(19) United States
(12) Patent Application Publication
(10) Pub. No.: US 2024/0414707 A1
(43) Pub. Date: Dec. 12, 2024

(54) TERMINAL AND COMMUNICATION METHOD

(71) Applicant: NTT DOCOMO, INC., Tokyo (JP)

(72) Inventors: Yuki TAKAHASHI, Tokyo (JP); Satoshi NAGATA, Tokyo (JP)

(73) Assignee: NTT DOCOMO, INC., Tokyo (JP)

(21) Appl. No.: 18/704,560

(22) PCT Filed: Oct. 27, 2021
(86) PCT No.: PCT/JP2021/039720

§ 371 Date: Apr. 25, 2024

(51) Int. Cl. H04W 72/1268; H04W 72/231; H04W 72/566

(52) U.S. Cl. CPC H04W 72/1268; H04W 72/231; H04W 72/566

(57) ABSTRACT

This terminal includes: a transmission unit that repeatedly transmits one or both of a first uplink signal which has a first priority level and which is given a configured uplink grant, and a second uplink signal which has a second priority level that is a lower priority level than the first priority level and which is given a dynamic uplink grant; and a control unit that determines to drop any second uplink signal that overlaps with the transmission timing of a first uplink signal.

### TECHNICAL FIELD

The present disclosure relates to a terminal and a communication method.

### BACKGROUND ART

Long Term Evolution (LTE) has been specified for achieving a higher data rate, lower latency, and the like in a Universal Mobile Telecommunication System (UMTS) network. Future systems of LTE have also been studied for achieving a broader bandwidth and a higher speed based on LTE. Examples of the future systems of LTE include systems called LTE-Advanced (LTE-A), Future Radio Access (FRA), 5th generation mobile communication system (5G), 5G plus (5G+), Radio Access Technology (New-RAT), New Radio (NR), and the like.

3GPP has developed schemes called Ultra-Reliable and Low Latency Communications (URLLC) and Industrial Internet of Things (IIoT) in Rel. 17, and several techniques have been approved (see, for example, Non-Patent Literature (hereinafter, referred to as “NPL”) 1). For example, in Rel. 17, a technique related to intra-terminal multiplexing and intra-terminal prioritization of traffic with different priority is approved (specified) based on work done in Rel. 16 (RAN1).

For example, a multiplexing behavior between HARQ-ACK/SR/CSI and a PUSCH for traffic with different priorities was specified, including the cases with UCI on a PUCCH and UCI on a PUSCH.

Also, PHY prioritization of overlapping dynamic grant PUSCH (DG PUSCH) and configured grant PUSCH (CG PUSCH) was specified, with the solution developed during Rel. 16 being taken as the baseline. The DG PUSCH and CG PUSCH may be of different physical priorities (PHY priorities) on a BWP of a serving cell, and the serving cell may include the related cancelation behavior for the PUSCH of lower PHY priority.

Note that RAN is an abbreviation for Radio Access Network. PUCCH is an abbreviation for Physical Uplink Control Channel. PUSCH is an abbreviation for a Physical Uplink Shared Channel. UCI is an abbreviation for Uplink Control Information. HARQ-ACK is an abbreviation for Hybrid Automatic Repeat request—Acknowledgement. SR is an abbreviation for Scheduling Request. CSI is an abbreviation for Channel State Information. BWP is an abbreviation for Band Width Part.

### CITATION LIST

### Non-Patent Literature

### NPL 1

“Enhanced Industrial Internet of Things (IoT) and ultra-reliable and low latency communication (URLLC) support for NR.” RP-201310, 3GPP TSG RAN Meeting #88e, 3GPP, 2020 June-July

### SUMMARY OF INVENTION

However, there has not been sufficient study on a terminal operation performed in a case of repetition transmission of a first uplink signal which has a first priority and for which uplink transmission configuration is granted, and a second uplink signal which has a second priority lower than the first priority and for which uplink transmission is dynamically granted. Accordingly, further study in this respect is demanded.

One aspect of the present disclosure is to provide a terminal and a communication method for appropriately transmitting a first uplink signal of a higher priority in a case where repetition transmission of a first uplink signal and a second signal is performed, the first uplink signal having a first priority and for which uplink transmission configuration is granted, the second uplink signal having a second priority lower than the first priority and for which the uplink transmission configuration is dynamically granted.

### Solution to Problem

A terminal according to one aspect of the present disclosure includes: a transmission section that repeatedly transmits one or both of a first uplink signal and a second uplink signal, the first uplink signal having a first priority and for which uplink transmission configuration is granted, the second uplink signal having a second priority lower than the first priority and for which the uplink transmission configuration is dynamically granted; and a control section that determines drop of the second uplink signal which is overlapping with the first uplink signal in transmission timing.

A communication method according to one aspect of the present disclosure includes steps performed by a terminal of: repeatedly transmitting one or both of a first uplink signal and a second uplink signal, the first uplink signal having a first priority and for which uplink transmission configuration is granted, the second uplink signal having a second priority lower than the first priority and for which the uplink transmission configuration is dynamically granted; and determining drop of the second uplink signal which is overlapping with the first uplink signal in transmission timing.

### BRIEF DESCRIPTION OF DRAWINGS

FIG. 1 is a diagram for explaining one example of agreed contents;

FIG. 2 is a diagram for explaining one example of discussed contents;

FIG. 3 is a diagram for explaining one example of Case 1-1 of Proposal 1;

FIG. 4 is a diagram for explaining one example of Case 1-1 of Proposal 1;

FIG. 5 is a diagram for explaining one example of Case 1-2 of Proposal 1;

FIG. 6 is a diagram for explaining one example of Case 1-2 of Proposal 1;

FIG. 7 is a diagram for explaining one example of Case 1-3 of Proposal 1;

FIG. 8 is a diagram for explaining one example of Case 1-3 of Proposal 1;

FIG. 9 is a diagram for explaining one example of Case 2-1 of Proposal 2;

FIG. 10 is a diagram for explaining one example of Case 2-1 of Proposal 2;

FIG. 11 is a diagram for explaining one example of Case 2-2 of Proposal 2;

FIG. 12 is a diagram for explaining one example of Case 2-2 of Proposal 2:

FIG. 13 is a diagram for explaining one example of Case 2-3 of Proposal 2;

FIG. 14 is a diagram for explaining one example of Case 2-3 of Proposal 2;

FIG. 15 illustrates one exemplary radio communication system according to one embodiment;

FIG. 16 illustrates one example of a frequency range used in a radio communication system;

FIG. 17 illustrates a configuration example of a radio frame, subframes, and slots used in the radio communication system;

FIG. 18 is a block diagram illustrating one example of a configuration of a base station according to an embodiment;

FIG. 19 is a block diagram illustrating one example of a configuration of a terminal according to an embodiment:

FIG. 20 illustrates exemplary hardware configurations of the base station and the terminal according to an embodiment; and

FIG. 21 illustrates one exemplary configuration of a vehicle according to an embodiment.

### DESCRIPTION OF EMBODIMENTS

Hereinafter, an embodiment according to an aspect of the present disclosure will be described in detail with reference to the accompanying drawings.

3GPP has developed the systems called URLLC and IIoT in Rel. 17. In 3GPP, the following agreement was made on an operation performed when a High priority (HP) CG PUSCH and a Low priority (LP) DG PUSCH overlap (overlap in time) with each other.

### Agreed Contents

When Media Access Control (MAC) of a terminal delivers two MAC PDUs to physical (PHY), PHY may make prioritization so that the terminal transmits the HP CG PUSCH and drops the LP DG PUSCH. The PHY may drop the LP DG PUSCH at latest from the first symbol that is overlapping with the HP CG PUSCH. Note that it may be up to terminal implementation (capability) to handle a symbol of the LP CG PUSCH which is not overlapping with the HP CG PUSCH.

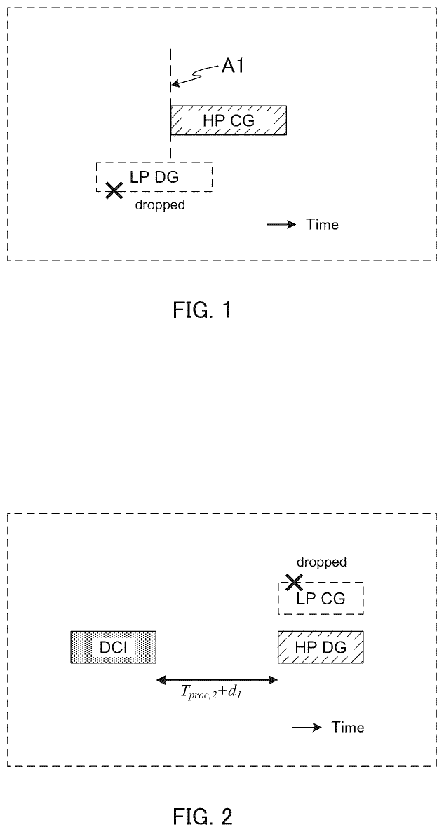

FIG. 1 is a diagram for explaining one example of agreed contents. HP CG and LP DG in FIG. 1 denote the HP CG PUSCH and LP DG PUSCH transmission timings.

The terminal may transmit the HP CG PUSCH and drop the LP DG PUSCH when the HP CG PUSCH and LP DG PUSCH overlap with each other. For example, the terminal may drop the LP DG PUSCH by the timing indicated by arrow A1 in FIG. 1 at the latest.

The terminal may or may not drop a symbol of the LP DG PUSCH which is not overlapping with the HP CG PUSCH. That is, the terminal may drop the entire LP DG PUSCH or may drop a part thereof.

For example, in FIG. 1, the terminal may drop the entire LP DG PUSCH. Further, the terminal may not drop an LP DG PUSCH which precedes the timing indicated by arrow A1 in FIG. 1 (LP DG PUSCH not overlapping with the HP CG PUSCH).

Note that dropping the DG PUSCH may be regarded as not transmitting the DG PUSCH. Not dropping the DG PUSCH may be regarded as transmitting the DG PUSCH. Dropping the CG PUSCH may be regarded as not transmitting the CG PUSCH. Not dropping the CG PUSCH may be regarded as transmitting the CG PUSCH.

Dropping may also be referred to as cancellation. The overlap may be referred to as collision. The MAC may be referred to as a MAC layer. The PHY may be referred to as a PHY layer. The symbols may be Orthogonal Frequency Division Multiplexing (OFDM) symbols.

The DG PUSCH may also be dynamically scheduled by physical layer signaling such as Downlink Control Information (DCI), for example. The DG PUSCH may be referred to as a dynamic PUSCH.

In addition, for NR, the configuration of CG PUSCH is defined in Release 16 (for example, see 3GPP TS38.331 V16.2.0). The CG PUSCH includes Type 1 CG PUSCH and Type 2 CG PUSCH. The CG PUSCH may be either Type 1 CG PUSCH or Type 2 CG PUSCH.

Transmission parameters of Type 1 CG PUSCH are provided by higher layer signalling such as “configuredGrantConfig.” “pusch-Config,” and “rrc-ConfiguredUplinkGrant.” Activation and deactivation of Type 1 CG PUSCH depend on RRC-configuration and are independent of the physical layer signaling such as DCI.

Transmission parameters of Type 2 CG PUSCH are provided by “configuredGrantConfig,” “pusch-Config,” and “activation DCI.” Activation and deactivation of Type 2 CG PUSCH depend on RRC-configuration and DCI. One DCI can activate one CG PUSCH and can deactivate a plurality of CG PUSCHs.

As described above, in 3GPP, the operation performed when the HP CG PUSCH and LP DG PUSCH overlap with each other has been agreed. On the other hand, the operation performed when the LP CG PUSCH and HP DG PUSCH overlap with each other is under consideration. In 3GPP, the operation performed when the LP CG PUSCH and HP DG PUSCH overlap with each other is discussed as follows.

### Discussion

The PHY layer may make prioritization such that the terminal is expected to drop the HP DG PUSCH at latest by the first symbol of LP CG PUSCH which is overlapping with the HP DG PUSCH. The terminal may expect that the first symbol of the HP DG PUSCH or the first symbol which is overlapping with the LP CG PUSCH is not before T_{proc,2}+d1 after the last symbol of a Physical Downlink Control Channel (PDCCH) for scheduling the HP DG PUSCH.

It should be noted that T_{proc,2} is a period of time required for the terminal to prepare PUSCH data after receiving a UL grant. The character “d1” denotes a period of time determined based on various parameters such as a value reported from the terminal. Thus, the terminal may expect that the first symbol of the HP DG PUSCH is at least not prior to the period of time taken to prepare the PUSCH after the last symbol of the PDCCH for scheduling the HP DG PUSCH.

FIG. 2 is a diagram for explaining one example of the discussed contents. The LP CG and HP DG in FIG. 2 illustrate the LP CG PUSCH and HP DG PUSCH transmission timings.

The terminal may drop the LP CG PUSCH at latest by the first symbol where the LP CG PUSCH and HP DG PUSCH overlap with each other.

For example, the terminal may expect that the first symbol of the HP DG PUSCH is not before T_{proc,2}+d1 after the last symbol of the PDCCH (DCI) scheduling the HP DG PUSCH as illustrated in FIG. 2. The terminal may drop the LP CG PUSCH overlapping with the HP DG PUSCH assumed to be not prior to T_{proc,2}+d1 after the last symbol of the PDCCH including the DCI.

### Analysis

However, there has not been sufficient study on a terminal operation performed in a case where the CG PUSCH and DG PUSCH overlap with each other when repetition transmission of both or one of the CG PUSCH and DG PUSCH with different priorities is performed (for example, see Section 6 in 3GPP TS38.331 V16.7.0).

Note that the following two cases may be assumed for the overlap between the CG PUSCH and DG PUSCH with different priorities.
Case 1: Overlap between HP CG PUSCH and LP DG PUSCH
   Case 2: Overlap between LP CG PUSCH and HP DG PUSCH

Each of above-described Cases 1 and 2 may assume the following cases for repetition transmissions of the CG PUSCH and DG PUSCH. In the following description. repetition transmission may be simply referred to as repetition.
Case 1: In the overlap between the HP CG PUSCH and LP DG PUSCH,
   Case 1-1: the HP CG PUSCH is with repetition and the LP DG PUSCH is without repetition
   Case 1-2: the HP CG PUSCH is without repetition and the LP DG PUSCH is with repetition
   Case 1-3: the HP CG PUSCH and LP DG PUSCH are with repetition
Case 2: In the overlap between the LP CG PUSCH and HP DG PUSCH,
   Case 2-1: the LP CG PUSCH is with repetition and the HP DG PUSCH is without repetition
   Case 2-2: the LP CG PUSCH is without repetition and the HP DG PUSCH is with repetition
   Case 2-3: the LP CG PUSCH and HP DG PUSCH are with repetition

Note that the phrase “without repetition” may be regarded as single transmission of HP CG PUSCH or LP CG PUSCH. Also, the phrase “without repetition” may be regarded as single transmission of LP DG PUSCH or HP DG PUSCH.

Hereinafter, the terminal operations performed in the above-described cases will be described.

### Proposal 1

Proposal 1 will be described in relation to the terminal operation performed when the HP CG PUSCH and LP DG PUSCH overlap with each other (Case 1 of Analysis). When the HP CG PUSCH and LP DG PUSCH overlap with each other, the terminal may drop the LP DG PUSCH having a lower priority than the HP CG PUSCH.

When MAC of the terminal delivers two MAC PDUs to PHY, PHY may make the prioritization so that the terminal is expected to transmit the HP CG PUSCH and drop the LP DG PUSCH at latest from the first symbol that is overlapping with the HP CG PUSCH.

Note that it may be up to terminal implementation to handle a symbol of the LP DG PUSCH which is not overlapping with the HP CG PUSCH. For example, when part of the LP DG PUSCH overlaps with the HP CG PUSCH, the terminal may or may not transmit a symbol of the LP DG PUSCH which is not overlapping with the HP CG PUSCH.

### Case 1-1

Case 1-1 will be described in relation to the terminal operation performed in the case of the HP CG PUSCH with repetition and the LP DG PUSCH without repetition.

In the case of the HP CG PUSCH with repetition and the LP DG PUSCH without repetition (in the case of the LP DG PUSCH of single transmission), the terminal may drop the LP DG PUSCH overlapping with the HP CG PUSCH with repetition.

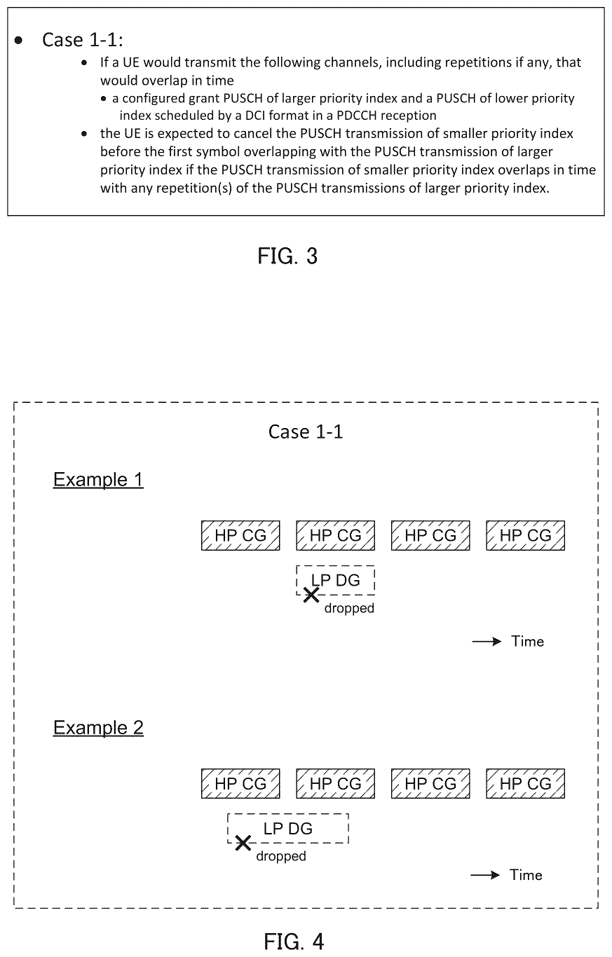

FIGS. 3 and 4 are views for explaining one example of Case 1-1 of Proposal 1. HP CG and LP DG illustrated in FIG. 4 indicate the HP CG PUSCH and LP DG PUSCH transmission timings. FIG. 4 illustrates two examples (Examples 1 and 2) of transmission timings of the HP CG PUSCH and LP DG PUSCH. FIG. 4 illustrates Case 1-1 of the HP CG PUSCH with repetition and the LP DG PUSCH of single transmission.

In Example 1 of FIG. 4, the single transmission of LP DG PUSCH overlaps with one HP CG PUSCH of the repetitions of HP CG PUSCHs. As illustrated in Example 1 of FIG. 4, the terminal may drop the LP DG PUSCH overlapping with the second repetition of HP CG PUSCH.

In Example 2 of FIG. 4, the single transmission of LP DG PUSCH overlaps with a plurality of HP CG PUSCHs of the repetitions of HP CG PUSCHs. As illustrated in Example 2 of FIG. 4, the terminal may drop the LP DG PUSCH overlapping with the first and the second repetitions of HP CG PUSCHs.

When the terminal includes repetition (when the terminal performs repetition of PUSCH), the terminal may be scheduled such that the CG PUSCH of a larger priority index (HP CG PUSCH) and the PUSCH of a smaller priority index (LP DG PUSCH) scheduled by the DCI (format) in a PDCCH reception overlap in time with each other. In addition, when the LP DG PUSCH (transmission) of a lower priority overlaps in time with the HP CG PUSCH (transmission) of a higher priority, the terminal may assume to drop the LP DG PUSCH before the first symbol of the LP DG PUSCH overlapping with the HP CG PUSCH.

Through the above-described operation, the terminal is capable of appropriately transmitting the HP CG PUSCH of a higher priority in the case of the HP CG PUSCH with repetition and the LP DG PUSCH without repetition and in the case where the HP CG PUSCH and LP DG PUSCH overlap with each other.

Note that each of the plurality of HP CG PUSCHs with repetition may be transmitted using one slot or one subslot. For example, one HP CG PUSCH illustrated in FIG. 4 may be transmitted using one slot or one subslot. The same applies to the cases of the LP DG PUSCH, LP CG PUSCH, and HP DG PUSCH with repetition.

Also, a plurality of HP CG PUSCHs with repetition may be transmitted using one slot or one subslot. For example, four HP CG PUSCHs illustrated in FIG. 4 may be transmitted using one slot or one subslot. When a plurality of HP CG PUSCHs with repetition are transmitted using one slot or one subslot, HARQ-ACK process IDs for the plurality of HP CG PUSCH may be different from one another. The same applies to the case of the LP DG PUSCH, LP CG PUSCH, and HP DG PUSCH with repetition.

### Case 1-2

Case 1-2 will be described in relation to the terminal operation performed in the case of the HP CG PUSCH without repetition and the LP DG PUSCH with repetition.

In the case of the HP CG PUSCH without repetition (the case of the HP CG PUSCH of single transmission) and the LP DG PUSCH with repetition, the terminal may drop the LP DG PUSCH overlapping with the HP CG PUSCH (see Option 1 below).

When the terminal performs single transmission of HP CG PUSCH and repeats the LP DG PUSCH, the terminal may drop an LP DG PUSCH overlapping the HP CG PUSCH and may also drop an LP DG PUSCH not overlapping with the HP CG PUSCH (see Options 2 and 3 below).

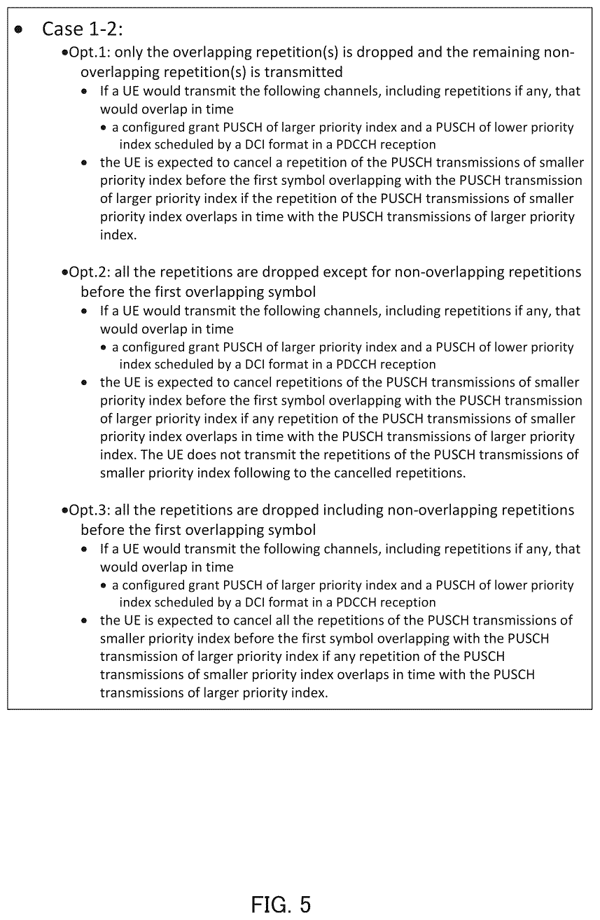

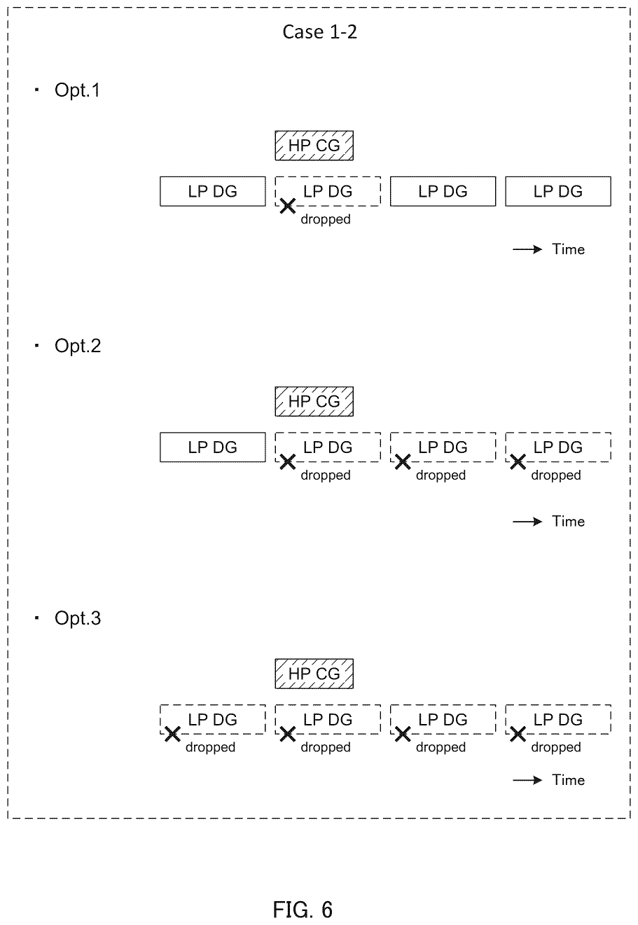

FIGS. 5 and 6 are views for explaining one example of Case 1-2 of Proposal 1. HP CG and LP DG illustrated in FIG. 6 indicate the HP CG PUSCH and LP DG PUSCH transmission timings. FIG. 6 illustrates one example of the HP CG PUSCH and LP DG PUSCH transmission timings in Options 1, 2, and 3 described below. FIG. 6 illustrates Case 1-2 of the HP CG PUSCH of single transmission and the LP DG PUSCH with repetition.

### Option 1

The terminal may drop the LP DG PUSCH overlapping with the HP CG PUSCH and not drop the LP DG PUSCHs not overlapping with the HP CG PUSCH. In other words, the terminal may drop only the LP DG PUSCH overlapping with the HP CG PUSCH and transmit remaining LP DG PUSCHs (the LP DG PUSCHs which are not overlapping with the HP CG PUSCH).

For example, of the four repetitions of LP DG PUSCHs, the terminal may drop the second LP DG PUSCH which is overlapping with the HP CG PUSCH as illustrated at Opt. 1 in FIG. 6. Then, the terminal may not drop the first, the third, and the fourth LP DG PUSCHs which are not overlapping with the HP CG PUSCH.

When the terminal includes repetition, the terminal may be scheduled such that the HP CG PUSCH of a larger priority index and the LP DG PUSCH of a smaller priority index scheduled by the DCI (format) in a PDCCH reception overlap in time with each other. In addition, when a repetition of LP DG PUSCH of a lower priority overlaps in time with a single transmission of HP CG PUSCH of a higher priority, the terminal may assume to drop the LP DG PUSCH before the first symbol of the LP DG PUSCH overlapping with the HP CG PUSCH.

Through the above-described operation, the terminal is capable of appropriately transmitting the HP CG PUSCH of a higher priority in the case of the HP CG PUSCH without repetition and the LP DG PUSCH with repetition and in the case where the HP CG PUSCH and LP DG PUSCH overlap with each other.

Note that when a plurality of LP DG PUSCHs overlap with one HP CG PUSCH, the terminal may drop a plurality of LP DG PUSCHs overlapping with one HP CG PUSCH.

### Option 2

The terminal may drop other LP DG PUSCHs of the repetitions of LP DG PUSCHs than an LP DG PUSCH which is before the first symbol overlapping with the HP CG PUSCH and which is not overlapping with the HP CG PUSCH. In other words, the terminal may drop the LP DG PUSCH overlapping with the HP CG PUSCH and drop the LP DG PUSCHs following to the dropped LP DG PUSCH.

For example, of the four repetitions of LP DG PUSCHs, the terminal may drop the second LP DG PUSCH which is overlapping with the HP CG PUSCH as illustrated at Opt. 2 in FIG. 6. Then, the terminal may drop the third and the fourth LP DG PUSCHs following to the dropped LP DG PUSCH (second LP DG PUSCH).

When the terminal includes repetition, the terminal may be scheduled such that the HP CG PUSCH of a larger priority index and the LP DG PUSCH of a smaller priority index scheduled by the DCI (format) in a PDCCH reception overlap in time with each other. In addition, when a repetition of LP DG PUSCH of a lower priority overlaps in time with a single transmission of HP CG PUSCH of a higher priority, the terminal may assume to drop the LP DG PUSCH before the first symbol of the LP DG PUSCH overlapping with the HP CG PUSCH. The terminal may also drop the LP DG PUSCHs following to the dropped LP DG PUSCH.

Through the above-described operation, the terminal is capable of appropriately transmitting the HP CG PUSCH of a higher priority in the case of the HP CG PUSCH without repetition and the LP DG PUSCH with repetition and in the case where the HP CG PUSCH and LP DG PUSCH overlap with each other. Further, the terminal drops the LP DG PUSCH overlapping with the HP CG PUSCH, and also drops the LP DG PUSCHs following to the dropped LP DG PUSCH. With this operation, the terminal is capable of reducing power consumption.

In the above description, the terminal drops the LP DG PUSCH overlapping with the HP CG PUSCH and the LP DG PUSCHs following to the LP DG PUSCH overlapping with the HP CG PUSCH, but the present invention is not limited thereto. The terminal may drop the LP DG PUSCH overlapping with the HP CG PUSCH and an LP DG PUSCH before the LP DG PUSCH overlapping with the HP CG PUSCH. For example, in Opt. 2 of FIG. 6, the terminal may drop the first and the second LP DG PUSCHs and not drop the third and the fourth LP DG PUSCHs.

### Option 3

The terminal may also drop an LP DG PUSCH of the repetitions of LP DG PUSCHs which is before the first symbol overlapping with a non-repeated HP CG PUSCH and which is not overlapping with the HP CG PUSCH. That is, the terminal may drop the LP DG PUSCH overlapping with the HP CG PUSCH and the remaining LP DG PUSCHs which are not overlapping with the HP CG PUSCH. In other words, the terminal may drop all the LP DG PUSCHs with repetition.

For example, of the four repetitions of LP DG PUSCHs, the terminal may drop the second LP DG PUSCH which is overlapping with the HP CG PUSCH as illustrated at Opt. 3 in FIG. 6. Then, the terminal may also drop the remaining LP DG PUSCHs (the first, the third, and the fourth LP DG PUSCHs) not overlapping with the HP CG PUSCH. That is, when the single transmission of HP CG PUSCH and the repetitions of LP DG PUSCHs overlap with each other, the terminal may drop all the repetitions of LP DG PUSCHs.

When the terminal includes repetition, the terminal may be scheduled such that the HP CG PUSCH of a larger priority index and the LP DG PUSCH of a smaller priority index scheduled by the DCI (format) in a PDCCH reception overlap in time with each other. In addition, when repetitions of LP DG PUSCH of a lower priority overlap in time with a single transmission of HP CG PUSCH of a higher priority, the terminal may assume to drop all the repetitions of LP DG PUSCHs before the first symbol of the LP DG PUSCH overlapping with the HP CG PUSCH.

Through the above-described operation, the terminal is capable of appropriately transmitting the HP CG PUSCH of a higher priority in the case of the HP CG PUSCH without repetition and the LP DG PUSCH with repetition and in the case where the HP CG PUSCH and LP DG PUSCH overlap with each other. The terminal drops the LP DG PUSCH overlapping with the HP CG PUSCH and also drops the remaining LP DG PUSCH which is not overlapping with HP CG PUSCH. With this operation, the terminal is capable of reducing power consumption.

### Case 1-3

Case 1-3 will be described in relation to the terminal operation performed in the case of the HP CG PUSCH and LP DG PUSCH with repetition.

In the case of the HP CG PUSCH and LP DG PUSCH with repetition, the terminal may drop an LP DG PUSCH overlapping with the HP CG PUSCH and not drop an LP DG PUSCH which is not overlapping with the HP CG PUSCH (see Option 1 below).

In the case of the HP CG PUSCH and LP DG PUSCH with repetition, the terminal may drop the LP DG PUSCH overlapping with the HP CG PUSCH and may also drop the LP DG PUSCH which is not overlapping with the HP CG PUSCH (see Options 2 and 3 below).

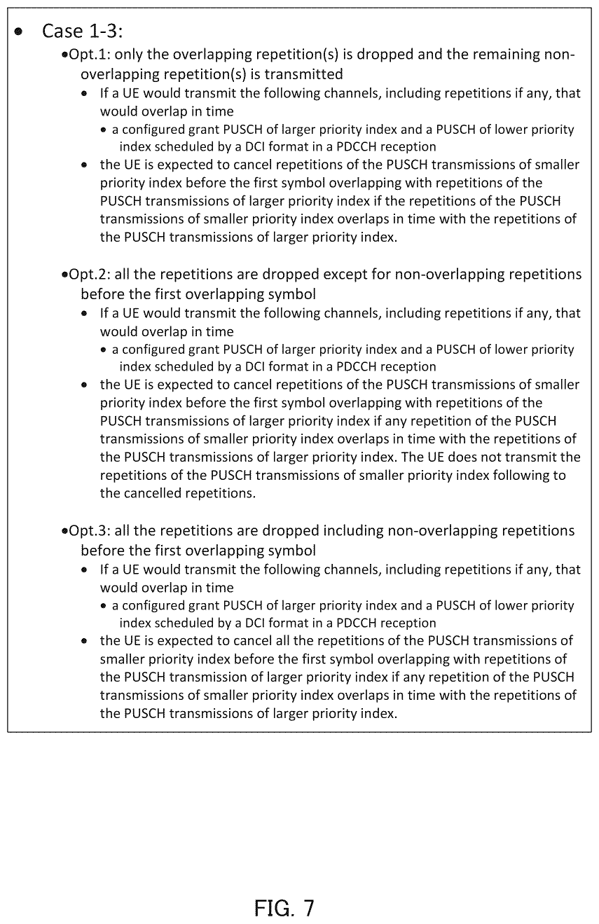

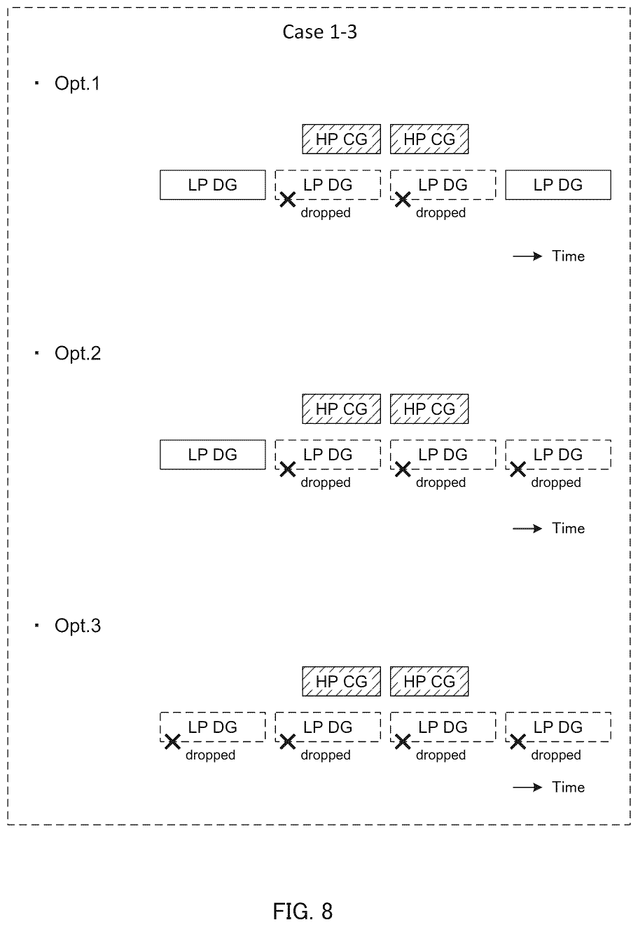

FIGS. 7 and 8 are views for explaining one example of Case 1-3 of Proposal 1. HP CG and LP DG illustrated in FIG. 8 indicate the HP CG PUSCH and LP DG PUSCH transmission timings. FIG. 8 illustrates one example of the HP CG PUSCH and LP DG PUSCH transmission timings in Options 1, 2, and 3 described below. FIG. 8 illustrates Case 1-3 of the HP CG PUSCH and LP DG PUSCH with repetition.

### Option 1

The terminal may drop the LP DG PUSCH overlapping with the HP CG PUSCH and not drop the LP DG PUSCH not overlapping with the HP CG PUSCH.

For example, of the four repetitions of LP DG PUSCHs, the terminal may drop the second and the third LP DG PUSCHs which are overlapping with the HP CG PUSCH as illustrated at Opt. 1 in FIG. 8. Then, the terminal may not drop the first and fourth LP DG PUSCHs which are not overlapping with the HP CG PUSCHs.

When the terminal includes repetition, the terminal may be scheduled such that the HP CG PUSCH of a larger priority index and the LP DG PUSCH of a smaller priority index scheduled by the DCI (format) in a PDCCH reception overlap in time with each other. In addition, when a repetition of LP DG PUSCH of a lower priority overlaps in time with a repetition of HP CG PUSCH of a higher priority, the terminal may assume to drop the LP DG PUSCH before the first symbol of LP DG PUSCH overlapping with the HP CG PUSCHs.

Through the above-described operation, the terminal is capable of appropriately transmitting the HP CG PUSCHs of a higher priority in a case of the HP CG PUSCH and LP DG PUSCH with repetition and in the case where the HP CGPUSCHs and the LP DG PUSCHs overlap with each other.

### Option 2

The terminal may drop other LP DG PUSCHs of the repetitions of LP DG PUSCHs than an LP DG PUSCH which is before the first symbol overlapping with the repetitions of HP CG PUSCHs and which is not overlapping with the HP CG PUSCHs. In other words, the terminal may drop the LP DG PUSCHs overlapping with the HP CG PUSCHs and drop the LP DG PUSCH following to the dropped LP DG PUSCHs.

For example, of the four repetitions of LP DG PUSCHs, the terminal may drop the second and the third LP DG PUSCHs which are overlapping with the HP CG PUSCHs as illustrated at Opt. 2 in FIG. 8. Then, the terminal may drop the fourth LP DG PUSCH following to the dropped LP DG PUSCHs (the second and the third LP DG PUSCHs).

When the terminal includes repetition, the terminal may be scheduled such that the HP CG PUSCH of a larger priority index and the LP DG PUSCH of a smaller priority index scheduled by the DCI (format) in a PDCCH reception overlap in time with each other. In addition, when a repetition of LP DG PUSCH of a lower priority overlaps in time with a repetition of HP CG PUSCH of a higher priority, the terminal may assume to drop the LP DG PUSCH before the first symbol of LP DG PUSCH overlapping with the HP CG PUSCH. The terminal may also drop the LP DG PUSCH following to the dropped LP DG PUSCH.

Through the above-described operation, the terminal is capable of appropriately transmitting the HP CG PUSCH of a higher priority in a case of the HP CG PUSCH and LP DG PUSCH with repetition and in the case where the HP CG PUSCH and the LP DG PUSCH overlap with each other. Further, the terminal drops the LP DG PUSCH overlapping with the HP CG PUSCH, and also drops the LP DG PUSCH following to the dropped LP DG PUSCH. With this operation, the terminal is capable of reducing power consumption.

In the above description, the terminal drops the LP DG PUSCH overlapping with the HP CG PUSCH and the LP DG PUSCH following to the LP DG PUSCH overlapping with the HP CG PUSCH, but the present invention is not limited thereto. The terminal may drop the LP DG PUSCH overlapping with the HP CG PUSCH and an LP DG PUSCH before the LP DG PUSCH overlapping with the HP CG PUSCH. For example, in Opt. 2 of FIG. 8, the terminal may drop the first, second, and third LP DG PUSCHs and not drop the fourth LP DG PUSCH.

### Option 3

The terminal may also drop an LP DG PUSCH of the repetitions of LP DG PUSCHs which is before the first symbol overlapping with the repetitions of HP CG PUSCHs and which is not overlapping with the HP CG PUSCH. That is, the terminal may drop the LP DG PUSCH overlapping with the HP CG PUSCH and the remaining LP DG PUSCHs which are not overlapping with the HP CG PUSCH. In other words, the terminal may drop all the LP DG PUSCHs with repetition.

For example, of the four repetitions of LP DG PUSCHs, the terminal may drop the second and the third LP DG PUSCHs which are overlapping with the HP CG PUSCH as illustrated at Opt. 3 in FIG. 8. Then, the terminal may also drop the remaining LP DG PUSCHs (the first and the fourth LP DG PUSCHs) not overlapping with the HP CG PUSCHs.

When the terminal includes repetition, the terminal may be scheduled such that the HP CG PUSCH of a larger priority index and the LP DG PUSCH of a smaller priority index scheduled by the DCI (format) in a PDCCH reception overlap in time with each other. In addition, when a repetition of LP DG PUSCH of a lower priority overlaps in time with a repetition of HP CG PUSCH of a higher priority, the terminal may assume to drop all the LP DG PUSCHs before the first symbol of LP DG PUSCH overlapping with the HP CG PUSCHs.

Through the above-described operation, the terminal is capable of appropriately transmitting the HP CG PUSCHs of a higher priority in a case of the HP CG PUSCH and LP DG PUSCH with repetition and in the case where the HP CG PUSCHs and the LP DG PUSCHs overlap with each other. The terminal drops the LP DG PUSCH overlapping with the HP CG PUSCH and also drops the remaining LP DG PUSCH which are not overlapping with the HP CG PUSCH. With this operation, the terminal is capable of reducing power consumption.

### Proposal 2

Proposal 2 will be described in relation to the terminal operation performed when the LP CG PUSCH and HP DG PUSCH overlap with each other (Case 2 of Analysis). The terminal may drop the LP CG PUSCH having a lower priority than the HP DG PUSCH. when the LP CG PUSCH and the HP DG PUSCH overlap with each other.

When MAC of the terminal delivers two MAC PDUs to PHY, PHY may make the prioritization so that the terminal is expected to drop the LP CG PUSCH at latest from the first symbol that is overlapping with the HP DG PUSCH. The terminal may expect that the first symbol of the HP DG PUSCH or the first symbol overlapping with the LP CG PUSCH is not before T_{proc,2}+d1 after the last symbol of the PDCCH for scheduling the HP DG PUSCH.

Note that another time parameter may be added to T_{proc,2}+d1 or T_{proc,2}+d1 may be replaced with another parameter. For example, as is expressed in T_{proc,2}+d1+d2, the time parameter which is determined based on various parameters such as values reported from the terminal and/or subcarrier spacing may be added.

Note that it may be up to terminal implementation to handle a symbol of the LP CG PUSCH which is not overlapping with the HP DG PUSCH. For example, when part of the LP CG PUSCH overlaps with the HP DG PUSCH, the terminal may or may not transmit a symbol of LP CG PUSCH not overlapping with the HP DG PUSCH.

### Case 2-1

Case 2-1 will be described in relation to the terminal operation performed in the case of the LP CG PUSCH with repetition and the HP DG PUSCH without repetition.

In the case of the LP CG PUSCH with repetition and the HP DG PUSCH without repetition (in the case of single transmission of HP DG PUSCH), the terminal may drop the LP CG PUSCH overlapping with the single transmission of HP DG PUSCH (see Option 1 below).

In the case of the LP CG PUSCH with repetition and the single transmission of HP DG PUSCH, the terminal may drop an LP CG PUSCH overlapping with the HP DG PUSCH and may also drop an LP CG PUSCH not overlapping with the HP DG PUSCH (see Options 2 and 3 below).

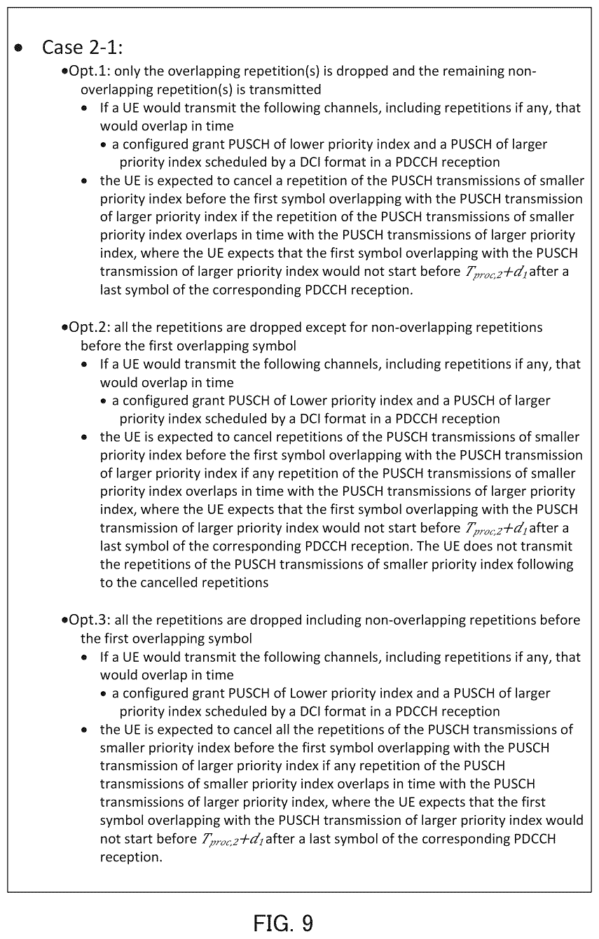

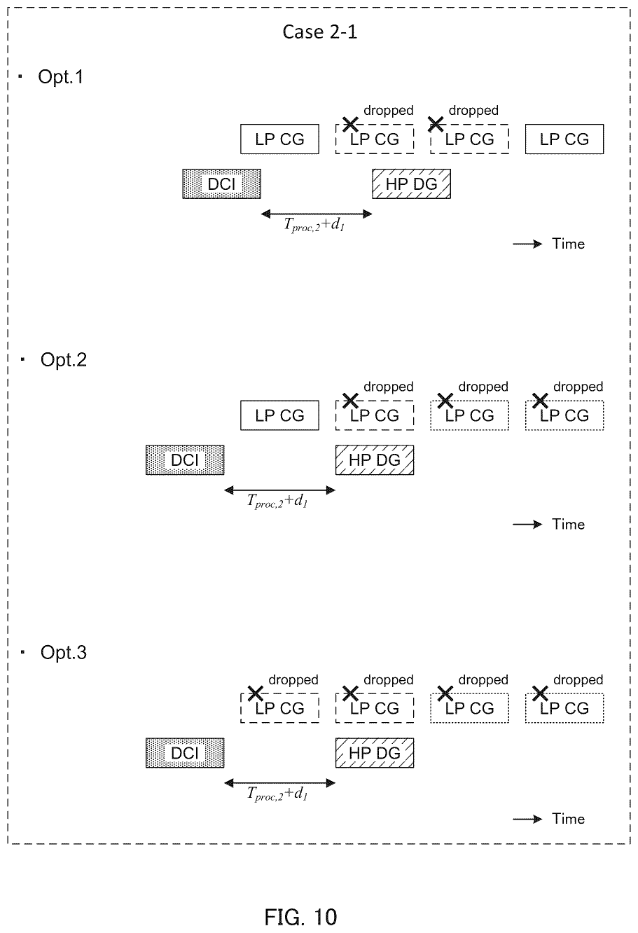

FIGS. 9 and 10 are views for explaining one example of Case 2-1 of Proposal 2. LP CG and HP DG illustrated in FIG. 10 indicate the LP CG PUSCH and HP DG PUSCH transmission timings. FIG. 10 illustrates exemplary LP CG PUSCH and HP DG PUSCH transmission timings in Options 1, 2, and 3 described below. FIG. 10 illustrates Case 2-1 of the LP CG PUSCH with repetition and the HP DG PUSCH of single transmission.

### Option 1

The terminal may drop the LP CG PUSCH overlapping with the HP DG PUSCH and not drop the LP CG PUSCH not overlapping with the HP DG PUSCH. In other words, the terminal may drop only the LP CG PUSCH overlapping with the HP DG PUSCH and transmit a remaining LP CG PUSCH (LP CG PUSCH not overlapping with the HP DG PUSCH).

For example, of the four repetitions of LP CG PUSCHs, the terminal may drop the second and the third LP CG PUSCHs which are overlapping with the HP DG PUSCH as illustrated at Opt. 1 in FIG. 10. In addition, the terminal may not drop the first and the fourth LP CG PUSCHs which are not overlapping with the HP DG PUSCH. In this case, the terminal may expect that the first symbol of the HP DG PUSCH is not before T_{proc,2}+d1 after the last symbol of the PDCCH (DCI) scheduling the HP DG PUSCH.

When the terminal includes repetition, the terminal may be scheduled such that the CG PUSCH of a smaller priority index (LP CG PUSCH) and the DG PUSCH of a larger priority index (HP DG PUSCH) scheduled by the DCI (format) in a PDCCH reception overlap in time with each other. In addition, when a repetition of LP CG PUSCH of a lower priority overlaps in time with a single transmission of HP DG PUSCH of a higher priority, the terminal may assume to drop the LP CG PUSCH before the first symbol of the LP CG PUSCH overlapping with the HP DG PUSCH. Here, the terminal may expect that the first symbol in which a single PUSCH transmission (single transmission of HP DG PUSCH) of a larger priority index and a repetition of PUSCH transmission (repetition of LP CG PUSCH) of a smaller priority index overlap with each other does not start before T_{proc,2}+d1 after the last symbol of the corresponding PDCCH reception.

Through the above-described operation, the terminal is capable of appropriately transmitting the HP DG PUSCH of the higher priority in the case of the HP DG PUSCH without repetition and the LP CG PUSCH with repetition and in the case where the HP DG PUSCH and the LP CG PUSCH overlap with each other.

### Option 2

The terminal may drop other LP CG PUSCHs of the repetitions of LP CG PUSCHs than an LP CG PUSCH which is before the first symbol overlapping with the HP DG PUSCH and which is not overlapping with the HP DG PUSCH. In other words, the terminal may drop the LP CG PUSCH overlapping with the HP DG PUSCH and drop the LP CG PUSCHs following to the dropped LP CG PUSCH.

For example, of the four repetitions of LP CG PUSCHs, the terminal may drop the second LP CG PUSCH which is overlapping with the HP DG PUSCH as illustrated in Opt. 2 of FIG. 10. In addition, the terminal may drop the third and the fourth LP CG PUSCHs following to the dropped LP CG PUSCH (second LP CG PUSCH).

When the terminal includes repetition, the terminal may be scheduled such that the LP CG PUSCH of a smaller priority index and the HP DG PUSCH of a larger priority index scheduled by the DCI (format) in a PDCCH reception overlap in time with each other. In addition, when a repetition of LP CG PUSCH of a lower priority overlaps in time with a single transmission of HP DG PUSCH of a higher priority, the terminal may assume to drop the LP CG PUSCH before the first symbol of the LP CG PUSCH overlapping with the HP DG PUSCH. The terminal may also drop the LP CG PUSCHs following to the dropped LP CG PUSCH. Here, the terminal may expect that the first symbol in which a single PUSCH transmission (single transmission of HP DG PUSCH) of a larger priority index and a repetition of PUSCH transmission (repetition of LP CG PUSCH) of a smaller priority index overlap with each other does not start before T_{proc,2}+d1 after the last symbol of the corresponding PDCCH reception.

Through the above-described operation, the terminal is capable of appropriately transmitting the HP DG PUSCH of the higher priority in the case of the HP DG PUSCH without repetition and the LP CG PUSCH with repetition and in the case where the HP DG PUSCH and the LP CG PUSCH overlap with each other. Further, the terminal drops the LP CG PUSCH overlapping with the HP DG PUSCH, and also drops the LP CG PUSCHS following to the dropped LP CG PUSCH. With this operation, the terminal is capable of reducing power consumption.

In the above description, the terminal drops the LP CG PUSCH overlapping with the HP DG PUSCH and the LP CG PUSCHs following to the HP DG PUSCH, but the present invention is not limited thereto. The terminal may drop an LP CG PUSCH overlapping with the HP DG PUSCH and an LP CG PUSCH before the LP CG PUSCH overlapping with the HP DG PUSCH. For example, at Opt. 2 in FIG. 10, the terminal may drop the first and the second LP CG PUSCHs and not drop the third and the fourth LP CG PUSCHs.

### Option 3

The terminal may also drop an LP CG PUSCH of the repetitions of LP CG PUSCHs which is before the first symbol overlapping with the HP DG PUSCH and which is not overlapping with the HP DG PUSCH. That is, the terminal may drop the LP CG PUSCH overlapping with the HP DG PUSCH and the remaining LP CG PUSCHs not overlapping with the HP DG PUSCH. In other words, the terminal may drop all the repetitions of LP CG PUSCHs.

For example, of the four repetitions of LP CG PUSCHs, the terminal may drop the second LP CG PUSCH overlapping with the HP DG PUSCH as illustrated in Opt. 3 of FIG. 10. Then, the terminal may also drop the remaining LP CG PUSCHs (the first, the third. and the fourth LP CG PUSCHs) not overlapping with the HP DG PUSCH. That is, when the single transmission of HP DG PUSCH and the repetitions of LP CG PUSCHs overlap with each other, the terminal may drop all the repetitions of LP CG PUSCHs.

When the terminal includes repetition, the terminal may be scheduled such that the LP CG PUSCH of a smaller priority index and the HP DG PUSCH of a larger priority index scheduled by the DCI (format) in a PDCCH reception overlap in time with each other. In addition, when the repetitions of LP CG PUSCHs of a lower priority overlap in time with the single transmission of HP DG PUSCH of a higher priority, the terminal may assume to drop all the repetitions of LP CG PUSCHs before the first symbol of the first repetition of LP CG PUSCH overlapping with the HP DG PUSCH.

Here, the terminal may expect that the first symbol in which a single PUSCH transmission (single transmission of HP DG PUSCH) of a larger priority index and a repetition of PUSCH transmission (repetition of LP CG PUSCH) of a smaller priority index overlap with each other does not start before T_{proc,2}+d1 after the last symbol of the corresponding PDCCH reception. Alternatively, the terminal may expect that the first symbol of the repetition of PUSCH transmission (repetition of LP CG PUSCH) of a smaller priority index overlapping with the single PUSCH transmission (single transmission of HP DG PUSCH) of a larger priority index does not start before T_{proc,2}+d1 after the last symbol of the corresponding PDCCH reception.

Through the above-described operation, the terminal is capable of appropriately transmitting the HP DG PUSCH of the higher priority in the case of the HP DG PUSCH without repetition and the LP CG PUSCH with repetition and in the case where the HP DG PUSCH and the LP CG PUSCH overlap with each other. The terminal also drops the LP CG PUSCH overlapping with the HP DG PUSCH and the remaining LP CG PUSCHs not overlapping with the HP DG PUSCH. With this operation, the terminal is capable of reducing power consumption.

### Case 2-2

Case 2-2 will be described in relation to the terminal operation performed in the case of the HP DG PUSCH with repetition and the LP CG PUSCH without repetition.

In the case of the HP DG PUSCH with repetition and the LP CG PUSCH without repetition (in the case of the LP CG PUSCH of single transmission), the terminal may drop the LP CG PUSCH overlapping with the repetition of HP DG PUSCH.

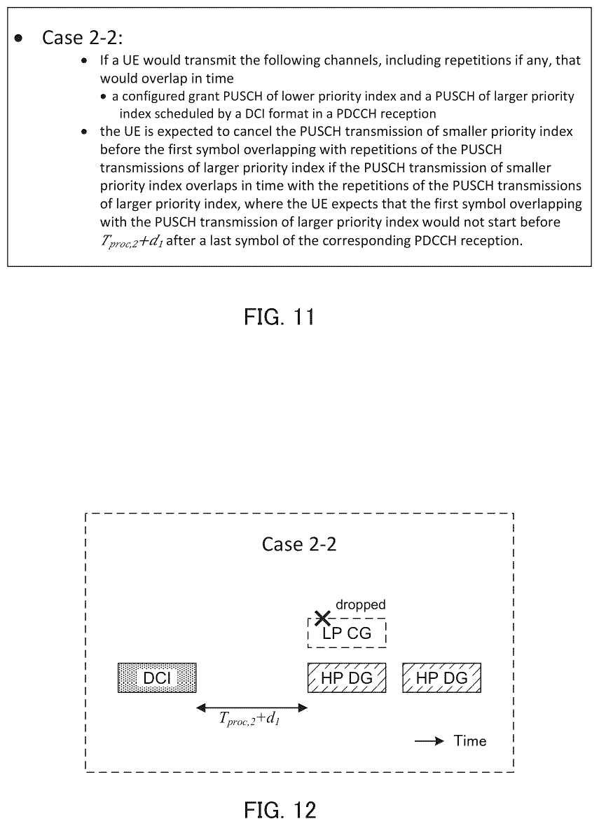

FIGS. 11 and 12 are views for explaining one example of Case 2-2 of Proposal 2. LP CG and HP DG illustrated in FIG. 12 indicate the LP CG PUSCH and HP DG PUSCH transmission timings. FIG. 12 illustrates Case 2-2 of the HP DG PUSCH with repetition and the LP CG PUSCH of single transmission.

For example, as illustrated in FIG. 12, the terminal may drop the single transmission of LP CG PUSCH overlapping with the first HP DG PUSCH of the two repetitions of HP DG PUSCHs.

When the terminal includes repetition, the terminal may be scheduled such that the

LP CG PUSCH of a smaller priority index and the HP DG PUSCH of a larger priority index scheduled by the DCI (format) in a PDCCH reception overlap in time with each other. In addition, when the single transmission of LP CG PUSCH of a lower priority overlaps in time with the repetitions of HP DG PUSCHs of a higher priority, the terminal may assume to drop the LP CG PUSCH before the first symbol of the LP CG PUSCH overlapping with the HP DG PUSCH. Here, the terminal may expect that the first symbol in which the a repetition of PUSCH transmission (repetition of HP DG PUSCH) of a larger priority index and the single PUSCH transmission (single transmission of LP CG PUSCH) of a smaller priority index overlap with each other does not start before T_{proc,2}+d1 after the last symbol of the corresponding PDCCH reception.

Through the above-described operation, the terminal is capable of appropriately

transmitting the HP DG PUSCH of the higher priority in the case of the HP DG PUSCH with repetition and the LP CG PUSCH without repetition and in the case where the HP DG PUSCH and the LP CG PUSCH overlap with each other.

### Case 2-3

Case 2-3 will be described in relation to the terminal operation performed in the case of the HP DG PUSCH and LP CG PUSCH with repetition.

In the case of the HP DG PUSCH and LP CG PUSCH with repetition, the terminal may drop the LP CG PUSCH overlapping with the HP DG PUSCH and not drop the LP CG PUSCH not overlapping with the HP DG PUSCH (see Option 1 below).

In the case of the HP DG PUSCH and LP CG PUSCH with repetition, the terminal may drop the LP CG PUSCH overlapping with the HP DG PUSCH and may also drop the LP CG PUSCH not overlapping with the HP DG PUSCH (see Options 2 and 3 below).

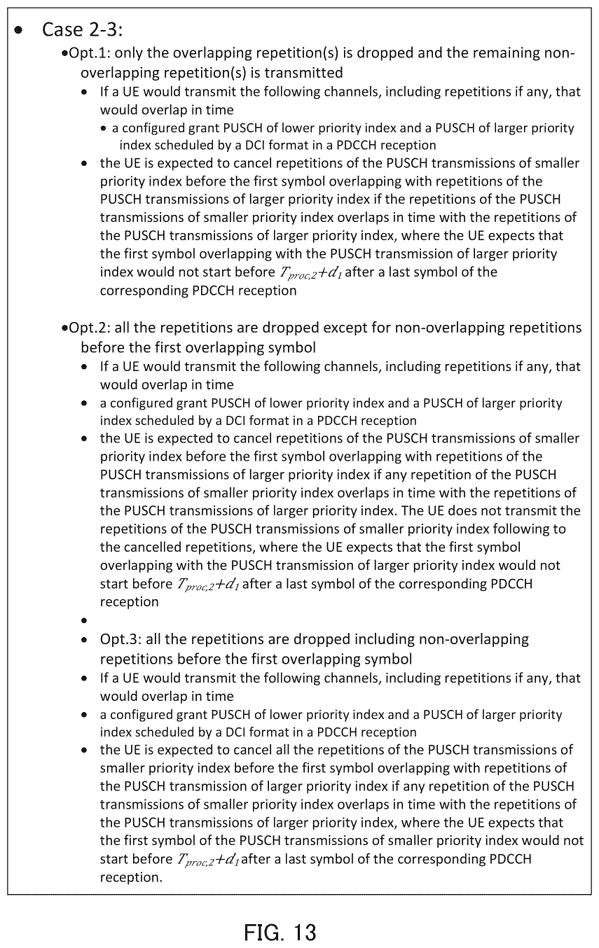

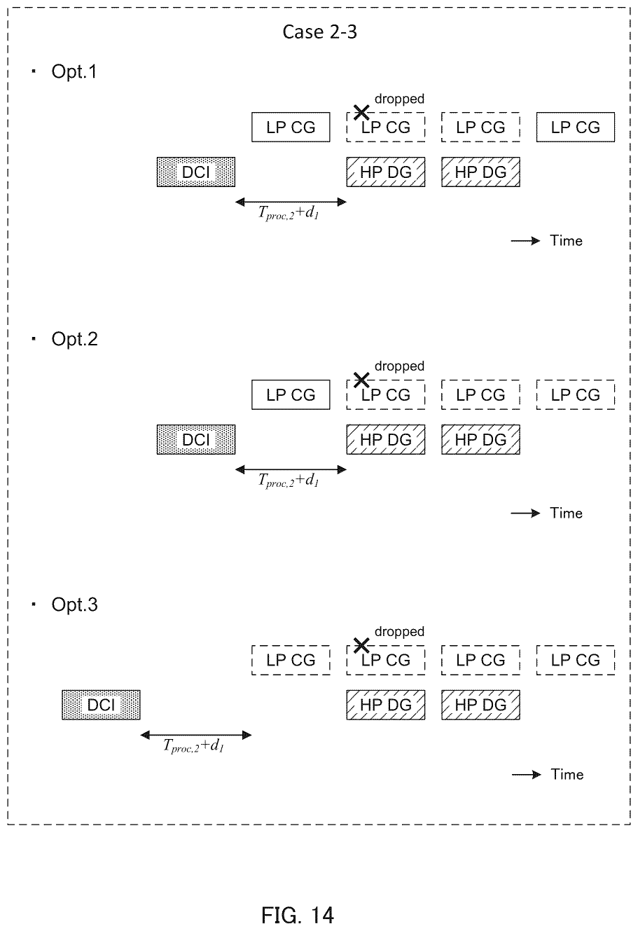

FIGS. 13 and 14 are views for explaining one example of Case 2-3 of Proposal 2. HP DG and LP CG illustrated in FIG. 14 indicate the HP DG PUSCH and LP CG PUSCH transmission timings. FIG. 14 illustrates exemplary HP DG PUSCH and LP CG PUSCH transmission timings in Options 1, 2, and 3 described below. FIG. 14 illustrates Case 2-3 of the HP DG PUSCH and LP CG PUSCH with repetition.

### Option 1

The terminal may drop the LP CG PUSCH overlapping with the HP DG PUSCH and not drop the LP CG PUSCH not overlapping with the HP DG PUSCH.

For example, of the four repetitions of LP CG PUSCHs, the terminal may drop the second and the third LP CG PUSCHs which are overlapping with the HP DG PUSCH as illustrated at Opt. 1 in FIG. 14. In addition, the terminal may not drop the first and the fourth LP CG PUSCHs which are not overlapping with the HP DG PUSCH.

When the terminal includes repetition, the terminal may be scheduled such that the LP CG PUSCH of a smaller priority index and the HP DG PUSCH of a larger priority index scheduled by the DCI (format) in a PDCCH reception overlap in time with each other. In addition, when the repetitions of LP CG PUSCHs of a lower priority overlap in time with the repetitions of HP DG PUSCHs of a higher priority, the terminal may assume to drop an LP CG PUSCH before the first symbol of the LP CG PUSCH overlapping with the HP DG PUSCH. Here, the terminal may expect that the first symbol in which a repetition of PUSCH transmission (repetition of HP DG PUSCH) of a larger priority index and a repetition of PUSCH transmission (repetition of LP CG PUSCH) of a smaller priority index overlap with each other does not start before T_{proc,2}+d1 after the last symbol of the corresponding PDCCH reception.

Through the above-described operation, the terminal is capable of appropriately transmitting the HP DG PUSCH of the higher priority in the case of the HP DG PUSCH and LP CG PUSCH with repetition and in the case where the HP DG PUSCH and the LP CG PUSCH overlap with each other.

### Option 2

The terminal may drop other LP CG PUSCHs of the repetitions of LP CG PUSCHs than an LP CG PUSCH which is before the first symbol overlapping with the repetitions of HP DG PUSCHs and which is not overlapping with the HP DG PUSCHs. In other words, the terminal may drop the LP CG PUSCH overlapping with the HP DG PUSCH and drop the LP CG PUSCHs following to the dropped LP CG PUSCH.

For example, of the four repetitions of LP CG PUSCHs, the terminal may drop the second and the third LP CG PUSCHs which are overlapping with the HP DG PUSCH as illustrated at Opt. 2 in FIG. 14. In addition, the terminal may drop the fourth LP CG PUSCH following to the dropped LP CG PUSCHs (the second and the third LP CG PUSCHs).

When the terminal includes repetition, the terminal may be scheduled such that the LP CG PUSCH of a smaller priority index and the HP DG PUSCH of a larger priority index scheduled by the DCI (format) in a PDCCH reception overlap in time with each other. In addition, when the repetitions of LP CG PUSCHs of a lower priority overlap in time with the repetitions of HP DG PUSCHs of a higher priority, the terminal may assume to drop an LP CG PUSCH before the first symbol of the LP CG PUSCH overlapping with the HP DG PUSCH. The terminal may also drop the LP CG PUSCHs following to the dropped LP CG PUSCH. Here, the terminal may expect that the first symbol in which the a repetition of PUSCH transmission (repetition of HP DG PUSCH) of a larger priority index and a repetition of PUSCH transmission (repetition of LP CG PUSCH) of a smaller priority index overlap with each other does not start before T_{proc,2}+d1 after the last symbol of the corresponding PDCCH reception.

Through the above-described operation, the terminal is capable of appropriately transmitting the HP DG PUSCH of the higher priority in the case of the HP DG PUSCH and LP CG PUSCH with repetition and in the case where the HP DG PUSCH and the LP CG PUSCH overlap with each other. Further, the terminal drops the LP CG PUSCH overlapping with the HP DG PUSCH, and also drops the LP CG PUSCHs following to the dropped LP CG PUSCH. With this operation, the terminal is capable of reducing power consumption.

In the above description, the terminal drops the LP CG PUSCHs overlapping with the HP DG PUSCHs and the LP CG PUSCH following to the HP DG PUSCHs, but the present invention is not limited thereto. The terminal may drop the LP CG PUSCHs overlapping with the HP DG PUSCHs and an LP CG PUSCH before the LP CG PUSCHs overlapping with the HP DG PUSCHs. For example, at Opt. 2 in FIG. 14, the terminal may drop the first, the second, and the third LP CG PUSCHs and not drop the fourth LP CG PUSCH.

### Option 3

The terminal may also drop an LP CG PUSCH of the repetitions of LP CG PUSCHs which is before the first symbol overlapping with the repetitions of HP DG PUSCHs and which is not overlapping with the HP DG PUSCHs. That is, the terminal may drop the LP CG PUSCHs overlapping with the HP DG PUSCHs and the remaining LP CG PUSCH not overlapping with the HP DG PUSCHs. In other words, the terminal may drop all the repetitions of LP CG PUSCHs.

For example, of the four repetitions of LP CG PUSCHs, the terminal may drop the second and the third LP CG PUSCHs which are overlapping with the HP DG PUSCHs as illustrated at Opt. 3 in FIG. 14. Then, the terminal may also drop the remaining LP CG PUSCHs (the first and the fourth LP CG PUSCHs) not overlapping with the HP DG PUSCH. When the terminal includes repetition, the terminal may be scheduled such that the LP CG PUSCH of a smaller priority index and the HP DG PUSCH of a larger priority index scheduled by the DCI (format) in a PDCCH reception overlap in time with each other. In addition, when the repetitions of LP CG PUSCHs of a lower priority overlap in time with the repetitions of HP DG PUSCHs of a higher priority, the terminal may assume to drop all the LP CG PUSCHs before the first symbol of the LP CG PUSCHs overlapping with the HP DG PUSCHs. Here, the terminal may expect that the first symbol of the PUSCH transmission (LP CG PUSCH) of a smaller priority index overlapping with the PUSCH transmission (HP DG PUSCH) of a larger priority index does not start before T_{proc,2}+d1 after the last symbol of the corresponding PDCCH reception.

Through the above-described operation, the terminal is capable of appropriately transmitting the HP DG PUSCH of the higher priority in the case of the HP DG PUSCH and LP CG PUSCH with repetition and in the case where the HP DG PUSCH and the LP CG PUSCH overlap with each other. The terminal also drops the LP CG PUSCH overlapping with the HP DG PUSCH and the remaining LP CG PUSCHs not overlapping with the HP DG PUSCH. With this operation, the terminal is capable of reducing power consumption. Note that, in this case, the terminal may expect that the first symbol of the LP CG PUSCH is not before T_{proc,2}+d1 after the last symbol of the DCI (PDCCH) scheduling the HP DG PUSCH. For example, as illustrated at Opt. 3 in FIG. 14, the terminal may expect that the first symbol of the repetitions of LP CG PUSCHs is not before T_{proc,2}+d1 after the last symbol of the PDCCH scheduling the HP DG PUSCH. The operations described above may also be applied to Options 1, 2, and 3 of Case 2-1, Case 2-2, and Options 1 and 2 of Case 2-3.

Also, at Opt. 3 in FIG. 14, the terminal may expect that the first symbol of the HP DG PUSCH is not before T_{proc,2}+d1 after the last symbol of the PDCCH scheduling HP DG PUSCH, as in the cases of Opt. 1 and Opt. 2 in FIG. 14.

The terminal may also expect that the first symbol of the HP DG PUSCH and LP CG PUSCH is not before T_{proc,2}+d1 after the last symbol of the PDCCH scheduling the HP DG PUSCH. The terminal may also expect that the first symbol of the HP CG PUSCH and LP DG PUSCH is not before T_{proc,2}+d1 after the last symbol of the PDCCH scheduling the HP DG PUSCH.

### Miscellaneous Note 1

The terminal may be configured with a plurality of CG PUSCHs. The priorities may be different between the plurality of CG PUSCHs.

For example, the terminal is configured with a first CG PUSCH and a second CG PUSCH. The first CG PUSCH is used as the HP CG PUSCH and the second CG PUSCH is used as the LP CG PUSCH. Repetition is assumed to be applied to both or one of the first CG PUSCH and the second CG PUSCH.

When the first CG PUSCH and the second CG PUSCH overlap with each other under the above-described conditions, the terminal may drop the second CG PUSCH of a lower priority (LP CG PUSCH) in accordance with the operations described in Proposals 1 and/or 2.

### Miscellaneous Note 2

The terminal may be configured with Type 1 CG PUSCH and Type 2 CG PUSCH. The priorities may be different between Type 1 CG PUSCH and Type 2 CG PUSCH.

For example, Type 1 CG PUSCH is used as the HP CG PUSCH and Type 2 CG PUSCH is used as the LP CG PUSCH. Repetition is assumed to be applied to both or one of Type 1 CG PUSCH and Type 2 CG PUSCH.

When Type 1 CG PUSCH and Type 2 CG PUSCH overlap with each other under the above-described conditions, the terminal may drop Type 2 CG PUSCH of a lower priority (LP CG PUSCH) in accordance with the operations described in Proposals 1 and/or 2.

### Variation

Which of the plurality of proposals is applied and/or which of the plurality of options is applied may be determined in the following method.
The proposal and/or option are configured by higher-layer parameters;
The proposal and/or option are reported by a UE as UE capability(ies);
The proposal and/or option are described in the specifications;
The proposal and/or option are determined based on the configuration of the higher-layer parameters and the reported UE capability: and
The proposal and/or option are determined by a combination of two or more of the above determinations.

The operations of the proposals and miscellaneous notes may be combined with one another. In addition, three or more kinds of priorities instead of two kinds of priorities (HP and LP) may be applied in the present disclosure.

### Terminal Capability

The UE capability representing the capability of a terminal may include the following information indicating the capability of the terminal. Note that the information indicating the capability of the terminal may be equivalent to information defining the capability of the terminal.
Information defining whether the terminal supports collision handling between the HP CG PUSCH and LP DG PUSCH
Information defining whether the terminal supports collision handling between repetitions of the HP CG PUSCH and LP DG PUSCH
Information defining whether the terminal supports collision handling between the LP CG PUSCH and HP DG PUSCH
Information defining whether the terminal supports collision handling between repetitions of the LP CG PUSCH and HP DG PUSCH

### Configuration of Radio System

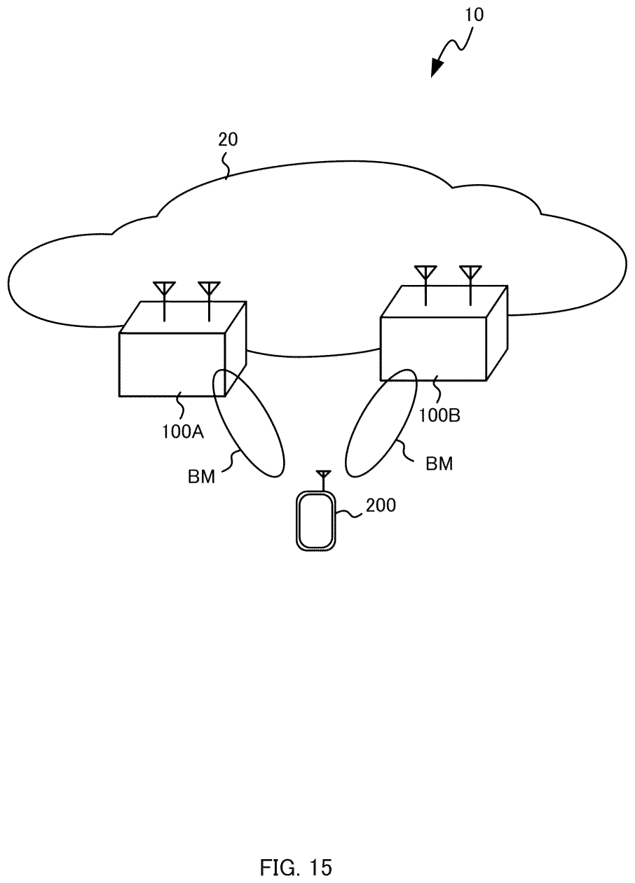

FIG. 15 illustrates one exemplary radio communication system 10 according to one embodiment. Radio communication system 10 is a radio communication system in accordance with 5G New Radio (NR), and includes Next Generation-Radio Access Network 20 (hereinafter, referred to as NG-RAN 20) and terminal 200 (hereinafter, referred to as UE 200).

Note that radio communication system 10 may be a radio communication system according to a system called Beyond 5G, 5G Evolution, or 6G.

NG-RAN 20 includes base station 100A (hereinafter, referred to as gNB 100A) and base station 100B (hereinafter, referred to as gNB 100B). When there is no need to distinguish between gNB 100A, gNB 100B, and the like, they are collectively referred to as gNB 100. The numbers of gNBs and UEs are not limited to those illustrated in FIG. 15.

In practice, NG-RAN 20 includes a plurality of NG-RAN nodes, in particular gNBs (or ng-eNBs), and is connected to a core network in accordance with 5G (“SGC,” which is not illustrated). Note that NG-RAN 20 and SGC may be simply expressed as “network.”

Both gNB 100A and gNB 100B are base stations in accordance with 5G, and perform radio communication with UE 200 in accordance with 5G. By controlling a radio signal transmitted from a plurality of antenna elements, gNB 100A, gNB 100B, and UE 200 may support Massive Multiple-Input Multiple-Output (MIMO) that generate beam BM with higher directivity, carrier aggregation (CA) that uses a plurality of component carriers (CCs) in a bundle, dual connectivity (DC) that performs communication between the UE and each of the two NG-RAN nodes, and the like. The DC may include Multi-RAT Dual Connectivity (MR-DC) using a Master Cell Group (MCG) and a Secondary Cell Group (SCG). Examples of the MR-DC include E-UTRA-NR Dual Connectivity (EN-DC). NR-EUTRA Dual Connectivity (NE-DC), NR-NR Dual Connectivity (NR-DC), and the like. Here, CCs (cells) used in CA may be considered to constitute the same cell group. The MCG and SCG may be considered to constitute the same cell group.

Further, radio communication system 10 supports a plurality of frequency ranges (FRs).

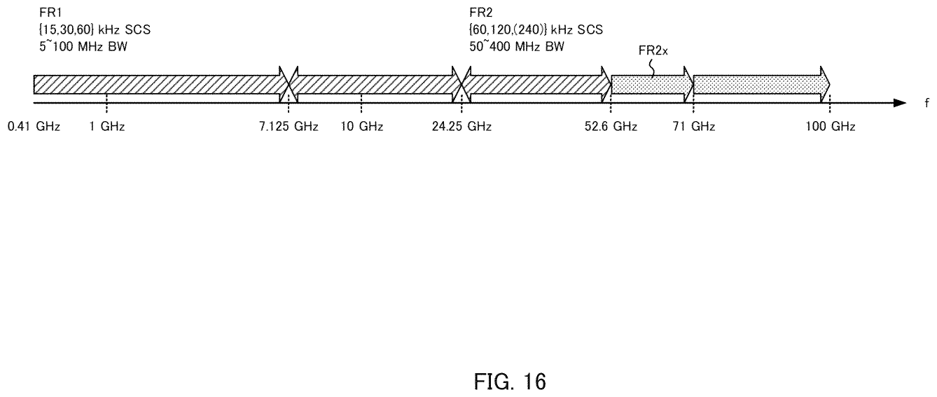

FIG. 16 illustrates exemplary frequency ranges used for radio communication system 10. As illustrated in FIG. 16, radio communication system 10 supports FR1 and FR2. For example, the frequency bands of the respective FRs are as follows.
FR: 410 MHz to 7.125 GHZ
FR2: 24.25 GHz to 52.6 GHZ

In FR1, a Sub-Carrier Spacing (SCS) of 15 kHz, 30 kHz or 60 kHz may be used, and a bandwidth (BW) of 5 to 100 MHz may be used. FR2 is higher than FR1 and may use a SCS of 60 kHz or 120 kHz (which may include 240 kHz), and a bandwidth (BW) of 50 to 400 MHz may be used.

The SCS may be interpreted as numerology. Numerology is defined in 3GPP TS38.300 and corresponds to one subcarrier spacing in the frequency domain.

Further, radio communication system 10 may support a higher frequency band than the FR2 frequency band. Specifically, radio communication system 10 may support a frequency band exceeding 52.6 GHz and up to 114.25 GHz. Such a high frequency band may be referred to as “FR2x” for convenience. When a bandwidth exceeding 52.6 GHz is used, Cyclic Prefix-Orthogonal Frequency Division Multiplexing (CP-OFDM)/Discrete Fourier Transform-Spread-Orthogonal Frequency Division Multiplexing (DFT-S-OFDM) having a greater SCS may be applied.

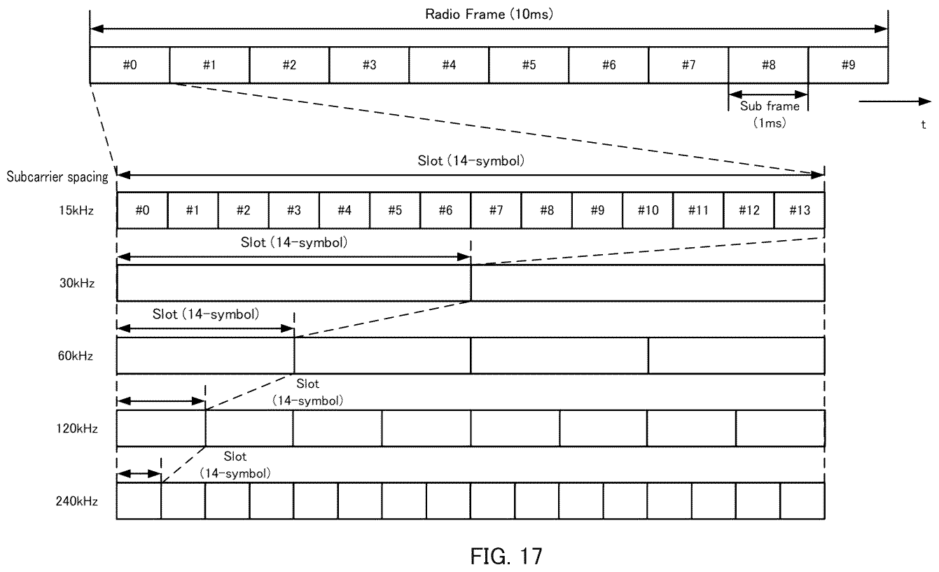

FIG. 17 illustrates a configuration example of a radio frame, a subframe, and a slot used in radio communication system 10. As illustrated in FIG. 17, one slot is composed of 14 symbols, and the symbol duration (and slot duration) becomes shorter as SCS becomes larger (wider). The SCS is not limited to the spacings (frequencies) illustrated in FIG. 17. For example, 480 kHz, 960 kHz, or the like may be used as the SCS.

Further, the number of symbols constituting one slot need not necessarily be 14 symbols (e.g., may be 28 symbols or 56 symbols). In addition, the number of slots per subframe may vary depending on SCS.

Note that the time direction (t) illustrated in FIG. 17 may be referred to as a time domain, a symbol duration, a symbol time, or the like. Further, the frequency direction may be referred to as a frequency domain, a resource block, a subcarrier, a bandwidth part (BWP), or the like.

### Configuration of Base Station

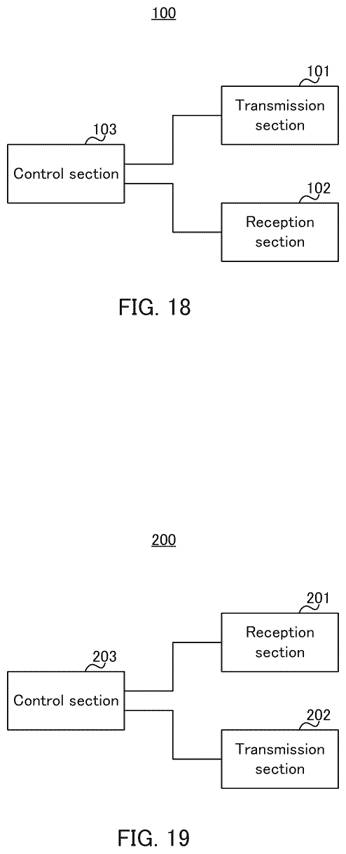

FIG. 18 is a block diagram illustrating one example of a configuration of base station 100 according to the embodiment. Base station 100 includes, for example, transmission section 101, reception section 102, and control section 103. Base station 100 communicates wirelessly with terminal 200 (see FIG. 19).

Transmission section 101 transmits a downlink (DL) signal to terminal 200. For example, transmission section 101 transmits the DL signal under the control of control section 103.

The DL signal may include, for example, a downlink data signal and control information (e.g., Downlink Control Information (DCI)). Further, the DL signal may include information indicating scheduling related to signal transmission of terminal 200 (e.g., UL grant). Moreover, the DL signal may include higher layer control information (e.g., Radio Resource Control (RRC) control information). Furthermore, the DL signal may include a reference signal.

Channels used for DL signal transmission include, for example, a data channel and a control channel For example, the data channel may include a Physical Downlink Shared Channel (PDSCH), and the control channel may include a Physical Downlink Control Channel (PDCCH). For example, the data channel may include the Physical Downlink Shared Channel (PDSCH), and the control channel may include the Physical Downlink Control Channel (PDCCH). For example, base station 100 transmits control information to terminal 200 using the PDCCH, and transmits a downlink data signal using the PDSCH.

The reference signal included in the DL signal may include, for example, at least one of a Demodulation Reference Signal (DMRS), a Phase Tracking Reference Signal (PTRS), a Channel State Information-Reference Signal (CSI-RS), a Sounding Reference Signal (SRS), and a Positioning Reference Signal (PRS) for position information. For example, the reference signal such as the DMRS and the PTRS is used for demodulation of a downlink data signal and is transmitted by using PDSCH.

Reception section 102 receives an uplink (UL) signal transmitted from terminal 200. For example, reception section 102 receives the UL signal under the control of control section 103.

Control section 103 controls communication operations of base station 100 including transmission processing in transmission section 101 and reception processing in reception section 102.

By way of example, control section 103 acquires information such as data and control information from a higher layer and outputs the data and control information to transmission section 101. Further, control section 103 outputs the data, the control information, and/or the like received from reception section 102 to the higher layer.

For example, control section 103 allocates resources (or channels) used for transmission and reception of the DL signal and/or resources used for transmission and reception of the UL signal based on a signal (e.g., data, control information, and the like) received from terminal 200 and/or data, control information, and the like obtained from the higher layer. Information on the allocated resources may be included in the control information to be transmitted to terminal 200.

As an example of the allocation of resources used for transmission and reception of the UL signal, control section 103 configures a PUCCH resource. Information on the configuration of the PUCCH (PUCCH configuration information) such as a PUCCH cell timing pattern may be indicated to terminal 200 by the RRC.

### Configuration of Terminal

FIG. 19 is a block diagram illustrating one example of a configuration of terminal 200 according to the embodiment. Terminal 200 includes, for example, reception section 201, transmission section 202, and control section 203. Terminal 200 communicates with base station 100 by radio, for example.

Reception section 201 receives the DL signal transmitted by base station 100. For example, reception section 201 receives the DL signal under the control of control section 203.

Transmission section 202 transmits an UL signal to base station 100. For example, transmission section 202 transmits the UL signal under the control of control section 203.

The UL signal may include, for example, an uplink data signal and control information (e.g., UCI). For example, information on processing capability of terminal 200 (e.g., UE capability) may also be included. Further, the UL signal may include a reference signal

Channels used for UL signal transmission include, for example, a data channel and a control channel. For example, the data channel includes a Physical Uplink Shared Channel (PUSCH) and the control channel includes a Physical Uplink Control Channel (PUCCH). For example, terminal 200 receives control information from base station 100 by using PUCCH and transmits an uplink data signal by using PUSCH.

The reference signal included in the UL signal may include, for example, at least one of a DMRS, a PTRS, a CSI-RS, an SRS, and a PRS. For example, the reference signal such as the DMRS and the PTRS is used for demodulation of an uplink data signal and is transmitted by using an uplink channel (e.g., PUSCH).

Control section 203 controls a communication operation of terminal 200 including a reception process of reception section 201 and a transmission process of transmission section 202.

By way of example, control section 203 acquires information such as data and control information from a higher layer and outputs the data and control information to transmission section 202. Further, control section 203 outputs, for example, the data, the control information, and/or the like received from reception section 201 to the higher layer. For example, control section 203 controls transmission of information to be fed

back to base station 100. The information to be fed back to base station 100 may include, for example, HARQ-ACK information, Channel State Information (CSI), and a Scheduling Request (SR). The information fed back to base station 100 may be included in the UCI. The UCI is transmitted in a PUCCH resource.

Control section 203 configures PUCCH resources based on the configuration information (e.g., configuration information such as the PUCCH cell timing pattern and/or DCI indicated by RRC) received from base station 100. Control section 203 determines the PUCCH resource to be used for transmitting the information to be fed back to base station 100. Transmission section 202 transmits the information to be fed back to base station 100 in the PUCCH resources determined by control section 203 under the control of control section 203.

Note that, the channels used for DL signal transmission and the channels used for UL signal transmission are not limited to the examples mentioned above. For example, the channels used for the DL signal transmission and the channels used for the UL signal transmission may include a Random Access Channel (RACH) and a Physical Broadcast Channel (PBCH). The RACH may be used for, for example, transmission of Downlink Control Information (DCI) including a Random Access Radio Network Temporary Identifier (RA-RNTI).

Here, transmission section 202 may perform repetition transmission of one or both of a first uplink signal which has a first priority and for which uplink transmission configuration is granted, and a second uplink signal which has a second priority lower than the first priority and for which the uplink transmission is dynamically granted. The first uplink signal may correspond to the HP CG PUSCH, and the second uplink signal may correspond to the LP DG PUSCH.

Control section 203 may determine drop of the second uplink signal overlapping (overlapping in time) with the first uplink signal in a transmission timing.

With the above configuration, the terminal is capable of appropriately transmitting the first uplink signal of a higher priority in a case where repetition transmission of one or both of the first uplink signal and the second uplink signal are to be performed, and the first uplink signal and the second uplink signal overlap with each other.

In addition, control section 203 may determine transmission of the second uplink signal which is not overlapping with the first uplink signal in the transmission timing.

With the above configuration, the terminal is capable of appropriately transmitting the second uplink signal which is not overlapping with the first uplink signal in the transmission timing.

In addition, control section 203 may determine transmission of a part of a plurality of the second uplink signals which are not overlapping with the first uplink signal in the transmission timing.

With the above configuration, the terminal is capable of appropriately transmitting the part of the plurality of second uplink signals which are not overlapping with the first uplink signal in the transmission timing. In addition, the terminal is capable of reducing power consumption by transmitting the part of the plurality of second uplink signals which are not overlapping with the first uplink signal in the transmission timing.

In addition, control section 203 may determine drop of all of the plurality of second uplink signals which are not overlapping with the first uplink signal in the transmission timing.

With the above configuration, the terminal is capable of reducing power consumption.

Here, transmission section 202 may repeatedly transmit one or both of a first uplink signal which has a first priority and for which uplink transmission configuration is granted, and a second uplink signal which has a second priority higher than the first priority and for which the uplink transmission is dynamically granted. The first uplink signal may correspond to the LP CG PUSCH, and the second uplink signal may correspond to the HP DG PUSCH.

Control section 203 may determine drop of the second uplink signal which is overlapping with the first uplink signal in the transmission timing.

With the above configuration, the terminal is capable of appropriately transmitting the second uplink signal of a higher priority in a case where repetition transmission of one or both of the first uplink signal and the second uplink signal are performed, and the first uplink signal and the second uplink signal overlap with each other.

Control section 203 may determine transmission of the first uplink signal which is not overlapping with the second uplink signal in the transmission timing.

With the above configuration, the terminal is capable of appropriately transmitting the first uplink signal which is not overlapping with the first uplink signal in the transmission timing.

In addition, control section 203 may determine transmission of a part of a plurality of the first uplink signals which are not overlapping with the second uplink signal in the transmission timing.

With the above configuration, the terminal is capable of appropriately transmitting the part of the plurality of first uplink signals which are not overlapping with the second uplink signal in the transmission timing. In addition, the terminal is capable of reducing power consumption by transmitting the part of the plurality of first uplink signals which are not overlapping with the second uplink signal in the transmission timing.

In addition, control section 203 may determine drop of all of the plurality of first uplink signals which are not overlapping with the second uplink signal in the transmission timing.

With the above configuration, the terminal is capable of reducing power consumption.

The present disclosure has been described above.

Hardware Configuration and/or the Like

Note that, the block diagrams used to describe the embodiment illustrate blocks on the basis of functions. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (for example, via wires or by radio), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmitting unit,” “transmission section,” or “transmitter.” The methods for implementing the functions are not limited specifically as described above. The methods for implementing the functions are not limited specifically as described above.

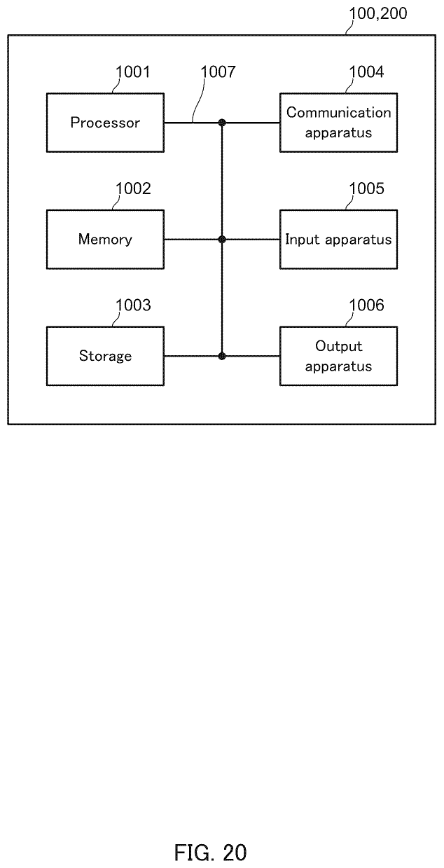

For example, base station 100, terminal 200, and the like according to an embodiment of the present disclosure may function as a computer that executes processing of a radio communication method of the present disclosure. FIG. 20 illustrates one example of a hardware configuration of base station 100 and terminal 200 according to the embodiment. Base station 100 and terminal 200 described above may be physically constituted as a computer apparatus including processor 1001, memory 1002, storage 1003, communication apparatus 1004, input apparatus 1005, output apparatus 1006, bus 1007, and the like.

Note that, the term “apparatus” in the following description can be replaced with a circuit, a device, a unit, or the like. The hardware configuration of base station 100 and terminal 200 may include one apparatus or a plurality of apparatuses illustrated in the drawings, or may not include part of the apparatuses.

The functions of base station 100 and terminal 200 are implemented by predetermined software (program) loaded into hardware such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, control section 103 and control section 203 as described above may be implemented by processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiment is used. For example, control section 203 of terminal 200 may be implemented by a control program stored in memory 1002 and operated by processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented by one or more chips. Note that, the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called a register, a cache, a main memory (main storage apparatus), or the like. Memory 1002 can save a program (program code), a software module, and the like that can be executed to carry out the radio communication method according to an embodiment of the present disclosure.

Storage 1003 is a computer-readable recording medium and may be composed of. for example, at least one of an optical disk such as a CD-ROM (Compact Disc ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be called an auxiliary storage apparatus. The storage medium as described above may be, for example, a database, a server or other appropriate media including at least one of memory 1002 and storage 1003.

Communication apparatus 1004 is hardware (transmission and reception device) for communication between computers through at least one of wired and radio networks and is also called as, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD). for example. For example, transmission section 101, reception section 102, reception section 201, transmission section 202, and the like as described above may be implemented by communication apparatus 1004.

Input apparatus 1005 is an input device (e.g., a keyboard, a mouse, a microphone, a switch, a button, or a sensor) that receives input from the outside. Output apparatus 1006 is an output device (e.g., a display, a speaker, or an LED lamp) which makes outputs to the outside. Note that input apparatus 1005 and output apparatus 1006 may be integrated (e.g., a touch panel).

The apparatuses, such as processor 1001, memory 1002 and the like, are connected by bus 1007 for communication of information. Bus 1007 may be configured using a single bus or using buses different between each pair of the apparatuses.

Furthermore, base station 100 and terminal 200 may include hardware, such as a microprocessor, a digital signal processor (DSP), an Application Specific Integrated Circuit (ASIC), a Programmable Logic Device (PLD), and a Field Programmable Gate Array (FPGA), and the hardware may implement part or all of the functional blocks. For example, processor 1001 may be implemented using at least one of these pieces of hardware.

### Notification and Signaling of Information

The notification of information is not limited to the embodiment described in the present disclosure, and the information may be notified by another method. For example, the notification of information may be carried out by one or a combination of physical layer signaling (for example, Downlink Control Information (DCI) and Uplink Control Information (UCI)), higher layer signaling (for example, Radio Resource Control (RRC) signaling, Medium Access Control (MAC) signaling, broadcast information (Master Information Block (MIB), and System Information Block (SIB))), and other signals. The RRC signaling may be called an RRC message and may be, for example, an RRC connection setup message, an RRC connection reconfiguration message, or the like.

### Applied System

The embodiment described in the present disclosure may be applied to at least one of a system using Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG) (“x” is an integer or an decimal, for example), Future Radio Access (FRA), New Radio access (NX), Future generation radio access (FX), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended, modified, created, or defined based on the above systems. Additionally or alternatively, a combination of two or more of the systems (e.g., a combination of at least LTE or LTE-A and 5G) may be applied.

### Processing Procedure and the Like

The orders of the processing procedures, the sequences, the flowcharts, and the like of the aspects and embodiment described in the present disclosure may be changed as long as there is no contradiction. For example, elements of various steps are presented in exemplary orders in the methods described in the present disclosure, and the methods are not limited to the presented specific orders.

### Operation of Base Station

Specific operations which are described in the present disclosure as being performed by the base station may sometimes be performed by an upper node depending on the situation. Various operations performed for communication with a terminal in a network constituted by one network node or a plurality of network nodes including a base station can be obviously performed by at least one of the base station and a network node other than the base station (examples include, but not limited to, Mobility Management Entity (MME) or Serving Gateway (S-GW)). Although there is one network node in addition to the base station in the case illustrated above, a plurality of other network nodes may be combined (e.g., MME and S-GW).

### Direction of Input and Output

The information or the like (see the item of “Information and Signals”) can be output from a higher layer (or a lower layer) to a lower layer (or a higher layer). The information or the like may be input and output through a plurality of network nodes.

### Handling of Input and Output Information and the Like

The input and output information and the like may be saved in a specific place (e.g., memory) or may be managed using a management table. The input and output information and the like can be overwritten, updated, or additionally written. The output information and the like may be deleted. The input information and the like may be transmitted to another apparatus.

### Determination Method

The determination may be made based on a value expressed by one bit (0 or 1), based on a Boolean value (true or false), or based on comparison with a numerical value (e.g., comparison with a predetermined value).

Variations and the like of Aspects

The aspects and embodiment described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiment described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

### Software

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (e.g., a coaxial cable, an optical fiber cable, a twisted pair, and a digital subscriber line (DSL)) and a radio technique (e.g., an infrared ray and a microwave), the at least one of the wired technique and the radio technique is included in the definition of the transmission medium.

### Information and Signals

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

### System and Network

The terms “system” and “network” used in the present disclosure can be interchangeably used.

### Names of Parameters and Channels

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the numerical formulas and the like using the parameters may be different from the ones explicitly disclosed in the present disclosure. Various channels (for example, PUCCH and PDCCH) and information elements, can be identified by any suitable names, and various names assigned to these various channels and information elements are not limitative in any respect.

### Base Station

The terms “Base Station (BS),” “radio base station,” “fixed station,” “NodeB,” “eNodeB (eNB),” “gNodeB (gNB),” “access point,” “transmission point,” “reception point, “transmission/reception point,” “cell.” “sector,” “cell group,” “carrier,” “component carrier,” and the like may be used interchangeably in the present disclosure. The base station may be called a macro cell, a small cell, a femtocell, or a pico cell.

The base station can accommodate one cell or a plurality of (e.g., three) cells. When the base station accommodates a plurality of cells, the entire coverage area of the base station can be divided into a plurality of smaller areas, and each of the smaller areas can provide a communication service based on a base station subsystem (e.g., small base station for indoor (RRH: Remote Radio Head)). The term “cell” or “sector” denotes part or all of the coverage area of at least one of the base station and the base station subsystem that perform the communication service in the coverage.

### Mobile Station

The terms “Mobile Station (MS),” “user terminal,” “User Equipment (UE),.” and “terminal” may be used interchangeably in the present disclosure.

The mobile station may be called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

### Base Station/Mobile Station

At least one of the base station and the mobile station may be called a transmission apparatus, a reception apparatus, a communication apparatus, or the like. Note that, at least one of the base station and the mobile station may be a device mounted in a mobile entity. the mobile entity itself, or the like. The mobile entity refers to a movable object, and has any moving speed. Naturally, the mobile entity in a state of being stopped is also encompassed. Examples of the mobile entity include, but are not limited to, vehicles, transport vehicles, automobiles, motorcycles, bicycles, connected cars, excavators, bulldozers, wheel loaders, dump trucks, forklifts, trains, buses, rear cars, manpower vehicles, ships and other watercrafts, airplanes, rockets, satellites, drones (registered trademark), multicopters, quadcopters, balloons, and goods loaded thereon. Further, the mobile entity may be a mobile entity that autonomously travels based on an operation command. The mobile entity may be a means of transport (e.g., a car, an airplane, or the like), an unmanned mobile entity (e.g., a drone, an autonomous driving vehicle, or the like), or a robot (a manned or unmanned robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the terminal. For example, the embodiments of the present disclosure may find application in a configuration that results from replacing communication between the base station and the terminal with communication between multiple terminals (such communication may, e.g., be referred to as device-to-device (D2D), vehicle-to-everything (V2X), or the like). In this case, terminal 200 may be configured to have the functions that base station 100 described above has. The wordings “uplink” and “downlink” may be replaced with a corresponding wording for inter-terminal communication (e.g., “side”). For example, an uplink channel, a downlink channel, and the like may be replaced with a side channel.

Similarly, the terminal in the present disclosure may be replaced with the base station. In this case, base station 100 is configured to have the functions that terminal 200 described above has.

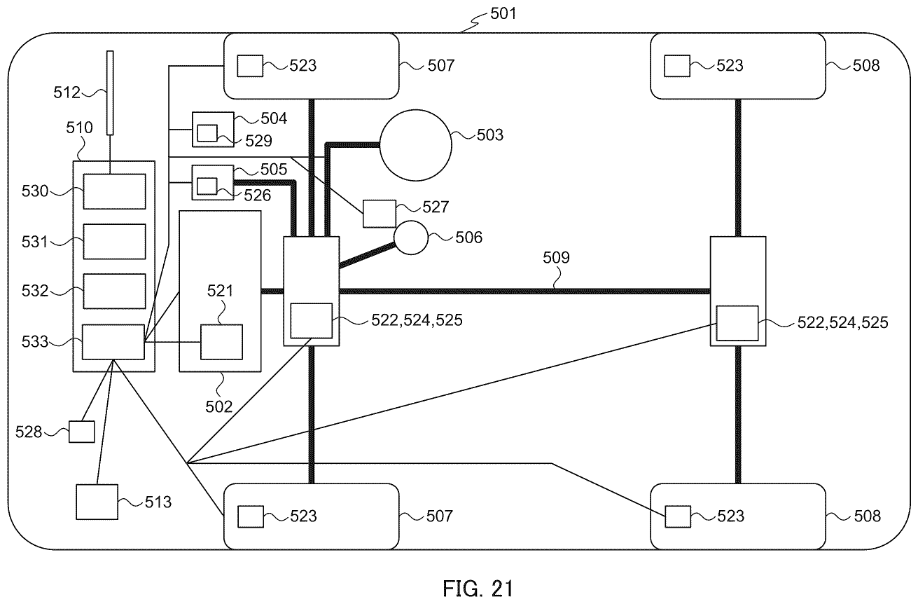

FIG. 21 illustrates a configuration example of vehicle 501. As illustrated in FIG. 21, vehicle 501 includes drive section 502, steering section 503, accelerator pedal 504, brake pedal 505, shift lever 506, left and right front wheels 507, left and right rear wheels 508, axle 509, electronic control section 510, various sensors 521 to 529, information service section 512, and communication module 513.

Drive section 502 is composed of, for example, an engine, a motor, or a hybrid of an engine and a motor.

Steering section 503 includes at least a steering wheel (also referred to as a handle) and is configured to steer at least one of the front and rear wheels based on an operation of the steering wheel operated by a user.

Electronic control section 510 includes microprocessor 531, memory (ROM and/or RAM) 532, and communication port (IO port) 533. Signals from various sensors 521 to 527 provided in the vehicle are inputted to electronic control section 510. Electronic control section 510 may be referred to as an Electronic Control Unit (ECU).

The signals from various sensors 521 to 528 include a current signal from current sensor 521 for sensing the current of the motor, a rotational speed signal of the front and/or rear wheels obtained by rotational speed sensors 522, a pneumatic signal of the front and/or rear wheels obtained by pneumatic sensors 523, a vehicle speed signal obtained by vehicle speed sensors 524, an acceleration signal obtained by acceleration sensors 525, an accelerator pedal depression amount signal obtained by accelerator pedal sensor 529, a brake pedal depression amount signal obtained by brake pedal sensor 526, an shift lever operation signal obtained by shift lever sensor 527, a detection signal for detecting an obstacle, a vehicle, a pedestrian, or the like obtained by object detection sensor 528, and the like.

Information service section 512 is composed of various devices such as a car navigation system, audio system, speaker, television, and radio for providing various types of information such as driving information, traffic information, entertainment information, and the like, and of one or more ECUs for controlling these devices. Information service section 512 provides various types of multimedia information and multimedia services to an occupant of vehicle 501 using information obtained from an external apparatus via communication module 513 or the like.

Driver assistance system section 530 is composed of various devices such as millimeter-wave radar, Light Detection and Ranging (LiDAR), a camera, a positioning locator (e.g., GNSS, etc.), a map information (e.g., high definition (HD) map, autonomous driving vehicle (AV) map, etc.), a gyrosystem (e.g., Inertial Measurement Unit (IMU), Inertial Navigation System (INS), etc.), an Artificial Intelligence (AI) chip, and an AI processor for providing functions for preventing accidents or reducing the driving load of the driver, and of one or more ECUs for controlling these devices. Driver assistance system section 530 transmits and receives various types of information via communication module 513, and realizes a driving support function or an autonomous driving function.

Communication module 513 can communicate with microprocessor 531 and the components of vehicle 501 via a communication port. For example, communication module 513 transmits and receives data to and from drive section 502, steering section 503, accelerator pedal 504, brake pedal 505, shift lever 506, left and right front wheels 507, left and right rear wheels 508, axle 509, and microprocessor 531 and memory (ROM and/or RAM) 532 in electronic control section 510, and sensors 521 to 528 provided in vehicle 501 via the communication port 533.

Communication module 513 is a communication device that can be controlled by microprocessor 531 of electronic control section 510 and can communicate with an external apparatus. For example, various kinds of information are transmitted and received to and from the external apparatus via radio communication. Communication module 513 may be either inside or outside electronic control section 510. The external apparatus may be, for example, a base station, a mobile station, or the like.

Communication module 513 transmits, to the external apparatus via radio communication, a current signal inputted from the current sensor to electronic control section 510. In addition, communication module 513 also transmits, to the external apparatus via radio communication, the rotational speed signal of the front and/or rear wheels obtained by rotation speed sensors 522, the pneumatic signal of the front and/or rear wheels obtained by pneumatic sensors 523, the vehicle speed signal obtained by vehicle speed sensors 524, the acceleration signal obtained by acceleration sensors 525, the accelerator pedal depression amount signal obtained by accelerator pedal sensor 529, the brake pedal depression amount signal obtained by brake pedal sensor 526, the shift lever operation signal obtained by shift lever sensor 527, the detection signal for detecting an obstacle, a vehicle, a pedestrian, and the like obtained by object detection sensor 528, and the like, which are signals inputted to electronic control section 510.

Communication module 513 receives various types of information (traffic information, signal information, inter-vehicle information, etc.) transmitted from the external apparatus, and displays the information on information service section 512 provided in the vehicle. Further, communication module 513 stores the various types of information received from the external apparatus in memory 532 accessible by microprocessor 531. Based on the information stored in memory 532, microprocessor 531 may perform control of drive section 502, steering section 503, accelerator pedal 504, brake pedal 505, shift lever 506, left and right front wheels 507, left and right rear wheels 508, axle 509, sensors 521 to 528, and the like provided in vehicle 501.

### Meaning and Interpretation of Terms

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in memory) and the like. Also, “determining” may be regarded as resolving, selecting, choosing, establishing, comparing and the like. That is, “determining” may be regarded as a certain type of action related to determining. Also, “determining” may be replaced with “assuming,” “expecting,” “considering,” and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

### Reference Signal

The reference signal can also be abbreviated as an RS and may also be called as a pilot depending on the applied standard.

### Meaning of “Based On”

The description “based on” used in the present disclosure does not mean “based only on,” unless otherwise specified. In other words, the description “based on” means both of “based only on” and “based at least on.”

### “First” and “Second”

Any reference to elements by using the terms “first,” “second,” and the like that are used in the present disclosure does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

### “Means”

The “means” in the configuration of each apparatus described above may be replaced with “section,” “circuit,” “device,” or the like.

### Open-Ended Format

In a case where terms “include,” “including,” and their modifications are used in the present disclosure, these terms are intended to be inclusive like the term “comprising.” Further, the term “or” used in the present disclosure is not intended to be an exclusive or.

Time Units such as TTI, Frequency Units Such as RB, and Radio Frame Configuration

The radio frame may be constituted by one frame or a plurality of frames in the time domain. The one frame or each of the plurality of frames may be called a subframe in the time domain. The subframe may be further constituted by one slot or a plurality of slots in the time domain. The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (e.g., 1 to 13 symbols) that is shorter than 1 ms, or a duration that is longer than 1 ms. Note that, a unit that represents the TTI may be referred to as a slot, a mini-slot, or the like instead of a subframe.

Here, the TTI, for example, refers to a minimum time unit for scheduling in radio communication. For example, in an LTE system, the base station performs scheduling for allocating a radio resource (frequency bandwidth, transmit power, and the like that are used in each user terminal) on a TTI-by-TTI basis to each user terminal. Note that, the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or more TTIs (that is, one or more slots, or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that the long TTI (for example, usual TTI, subframe, or the like) may be replaced with the TTI that has a time length which exceeds 1 ms, and the short TTI (for example, shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in the time domain, and may have a length of one slot, one mini slot, one subframe, or one TTI. One TTI and one subframe may be constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that. “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

### Maximum Transmit Power

The “maximum transmit power” described in the present disclosure may mean a maximum value of the transmit power, the nominal UE maximum transmit power, or the rated UE maximum transmit power.

### Article

In a case where articles, such as “a,” “an,” and “the” in English, for example, are added in the present disclosure by translation, nouns following these articles may have the same meaning as used in the plural.

### “Different”

In the present disclosure, the expression “A and B are different” may mean that “A and B are different from each other.” Note that, the expression may also mean that “A and B are different from C.” The expressions “separated” and “coupled” may also be interpreted in the same manner as the expression “A and B are different.”

### INDUSTRIAL APPLICABILITY

An aspect of the present disclosure is useful for radio communication systems.

### REFERENCE SIGNS LIST

10 Radio Communication System
100 Base station
200 Terminal
101, 202 Transmission section
102, 201 Reception section
103, 203 Control section

1-5. (canceled)

6. A terminal, comprising:
a transmitter that repeatedly transmits both a first uplink signal of a configured grant and a second uplink signal, the first uplink signal having a first priority, and the second uplink signal having a second priority lower in priority than the first priority, repeated transmission of the second uplink signal being scheduled by downlink control information; and
a controller that determines to cancel a transmission of the second uplink signal that overlaps in time with a transmission of the first uplink signal.

7. The terminal according to claim 6, wherein the controller determines to cancel the transmission of the second uplink signal before transmission of a first symbol of the second uplink signal, the first symbol overlapping in time with the first uplink signal.

8. The terminal according to claim 6, wherein:
the transmitter transmits a third uplink signal without repetition, the third uplink signal having the second priority and being scheduled by the downlink control information, and
the controller determines to cancel the third uplink signal that overlaps in time with the first uplink signal.

9. The terminal according to claim 6, wherein the controller determines to cancel, among the second uplink signals to be repeatedly transmitted, a second uplink signal that overlaps in time with the first uplink signal and determines not to cancel, among the second uplink signals to be repeatedly transmitted, a second uplink signal that does not overlap in time with the first uplink signal.

10. A radio system, comprising:
a terminal including:
a transmitter that repeatedly transmits both a first uplink signal of a configured grant and a second uplink signal, the first uplink signal having a first priority, and the second uplink signal having a second priority lower in priority than the first priority, repeated transmission of the second uplink signal being scheduled by downlink control information; and
a controller that determines to cancel a transmission of the second uplink signal that overlaps in time with a transmission of the first uplink signal; and
a base station including:
a receiver that receives the first uplink signal and causes the second uplink signal that overlaps in time with the first uplink signal, to be cancelled.

11. A communication method, comprising:
repeatedly transmitting, by a terminal, both a first uplink signal of a configured grant and a second uplink signal, the first uplink signal having a first priority, and the second uplink signal having a second priority lower in priority than the first priority, repeated transmission of the second uplink signal being scheduled by downlink control information; and
determining, by the terminal, to cancel a transmission of the second uplink signal that overlaps in time with a transmission of the first uplink signal.
